(19) United States
(12) Patent Application Publication
(10) Pub. No.: US 2024/0168802 A1
(43) Pub. Date: May 23, 2024

(54) PARALLEL PROCESSING WITH HAZARD DETECTION AND STORE PROBES

(71) Applicant: Ascenium, Inc., Mountain View, CA (US)

(72) Inventor: Peter Foley, Los Altos Hills, CA (US)

(73) Assignee: Ascenium, Inc., Mountain View, CA (US)

(21) Appl. No.: 18/426,438

(22) Filed: Jan. 30, 2024

Related U.S. Application Data
(63) Continuation of application No. 17/526,003, filed on Nov. 15, 2021.
Application No. 17/526,003 is a continuation of application No. 17/465,949, filed on Sep. 3, 2021.
(60) Provisional application No. 63/536,144, filed on Sep. 1, 2023.
(60) Provisional application No. 63/529,159, filed on Jul. 27, 2023.
(60) Provisional application No. 63/460,909, filed on Apr. 21, 2023.
(60) Provisional application No. 63/447,915, filed on Feb. 24, 2023.
(60) Provisional application No. 63/442,131, filed on Jan. 31, 2023.
(60) Provisional application No. 63/254,557, filed on Oct. 12, 2021.
(60) Provisional application No. 63/232,230, filed on Aug. 12, 2021.
(60) Provisional application No. 63/229,466, filed on Aug. 4, 2021.
(60) Provisional application No. 63/193,522, filed on May 26, 2021.
(60) Provisional application No. 63/166,298, filed on Mar. 26, 2021.
(60) Provisional application No. 63/125,994, filed on Dec. 16, 2020.
(60) Provisional application No. 63/114,003, filed on Nov. 16, 2020.
(60) Provisional application No. 63/091,947, filed on Oct. 15, 2020.
(60) Provisional application No. 63/075,849, filed on Sep. 9, 2020.

(51) Int. Cl. G06F 9/48; G06F 9/50

(52) U.S. Cl. CPC G06F 9/4881; G06F 9/5016; G06F 9/5027

(57) ABSTRACT

Techniques for parallel processing using hazard detection and store probes are disclosed. An array of compute elements is accessed. Each compute element within the array of compute elements is known to a compiler and is coupled to its neighboring compute elements within the array of compute elements. Control for the compute elements is provided on a cycle-by-cycle basis. Control is enabled by a stream of wide control words generated by the compiler. Data to be stored by the array of compute elements is managed. The data to be stored is targeted to a data cache coupled to the array of compute elements. The managing includes detecting and mitigating memory hazards. Pending data cache accesses are probed for hazards. The examining comprises a store probe. Store data is committed to the data cache. The committing is based on a result of the store probe.

### RELATED APPLICATIONS

This application claims the benefit of U.S. provisional patent applications “Parallel Processing With Hazard Detection And Store Probes” Ser. No. 63/442,131, filed Jan. 31, 2023, “Parallel Processing Architecture For Branch Path Suppression” Ser. No. 63/447,915, filed Feb. 24, 2023, “Parallel Processing Hazard Mitigation Avoidance” Ser. No. 63/460,909, filed Apr. 21, 2023, “Parallel Processing Architecture With Block Move Support” Ser. No. 63/529,159, filed Jul. 27, 2023, and “Parallel Processing Architecture With Block Move Backpressure” Ser. No. 63/536,144, filed Sep. 1, 2023.

This application is also a continuation-in-part of U.S. patent application “Highly Parallel Processing Architecture With Compiler” Ser. No. 17/526,003, filed Nov. 15, 2021, which claims the benefit of U.S. provisional patent applications “Highly Parallel Processing Architecture With Compiler” Ser. No. 63/114,003, filed Nov. 16, 2020, “Highly Parallel Processing Architecture Using Dual Branch Execution” Ser. No. 63/125,994, filed Dec. 16, 2020, “Parallel Processing Architecture Using Speculative Encoding” Ser. No. 63/166,298, filed Mar. 26, 2021, “Distributed Renaming Within A Statically Scheduled Array” Ser. No. 63/193,522, filed May 26, 2021, “Parallel Processing Architecture For Atomic Operations” Ser. No. 63/229,466, filed Aug. 4, 2021, “Parallel Processing Architecture With Distributed Register Files” Ser. No. 63/232,230, filed Aug. 12, 2021, and “Load Latency Amelioration Using Bunch Buffers” Ser. No. 63/254,557, filed Oct. 12, 2021.

The U.S. patent application “Highly Parallel Processing Architecture With Compiler” Ser. No. 17/526,003, filed Nov. 15, 2021 is also a continuation-in-part of U.S. patent application “Highly Parallel Processing Architecture With Shallow Pipeline” Ser. No. 17/465,949, filed Sep. 3, 2021, which claims the benefit of U.S. provisional patent applications “Highly Parallel Processing Architecture With Shallow Pipeline” Ser. No. 63/075,849, filed Sep. 9, 2020, “Parallel Processing Architecture With Background Loads” Ser. No. 63/091,947, filed Oct. 15, 2020, “Highly Parallel Processing Architecture With Compiler” Ser. No. 63/114,003, filed Nov. 16, 2020, “Highly Parallel Processing Architecture Using Dual Branch Execution” Ser. No. 63/125,994, filed Dec. 16, 2020, “Parallel Processing Architecture Using Speculative Encoding” Ser. No. 63/166,298, filed Mar. 26, 2021, “Distributed Renaming Within A Statically Scheduled Array” Ser. No. 63/193,522, filed May 26, 2021, Parallel Processing Architecture For Atomic Operations” Ser. No. 63/229,466, filed Aug. 4, 2021, and “Parallel Processing Architecture With Distributed Register Files” Ser. No. 63/232,230, filed Aug. 12, 2021.

Each of the foregoing applications is hereby incorporated by reference in its entirety.

### FIELD OF ART

This application relates generally to parallel processing and more particularly to parallel processing with hazard detection and store probes.

### BACKGROUND

Organizations process immense, varied, and at times unstructured datasets to support a wide variety of organizational missions and purposes. The purposes include commercial, educational, governmental, medical, research, or retail purposes, to name only a few. The datasets can also be analyzed for forensic and law enforcement purposes. Computational resources are obtained and implemented by the organizations to meet organizational needs. The organizations range in size from sole proprietor operations to large, international organizations. The computational resources include processors, data storage units, networking and communications equipment, telephony, power conditioning units, HVAC equipment, and backup power units, among other essential equipment. Energy resource management is also critical since the computational resources consume vast amounts of energy and produce copious heat. The computational resources can be housed in special-purpose installations that frequently require high levels of security. These installations more closely resemble high-security bases or even vaults than traditional office buildings. Not every organization requires vast computational equipment installations, but all strive to provide resources to meet their data processing needs as quick and cost effective a manner as possible.

The computational resource installations process data, typically 24×7×365. The types of data processed derive from the organizational missions. The organizations execute large numbers of a wide variety of processing jobs. The processing jobs include running billing and payroll, generating profit and loss statements, processing tax returns or election results, controlling experiments, analyzing research data, and generating academic grades, among others. These processing jobs must be executed quickly, accurately, and cost-effectively. The processed datasets can be very large, thereby straining the computational resources. Further, the datasets can be unstructured. As a result, processing an entire dataset may be required to find a particular data element. Effective processing of a dataset can be a boon for an organization, as it can allow for quickly identifying potential customers, fine tuning production and distribution systems, among other results that can yield a competitive advantage to the organization. Ineffective processing wastes money by losing sales or failing to streamline a process, thereby increasing costs.

Organizations implement a wide variety of data collection techniques in order to collect their data. The techniques harvest the data from a diversity of sources and individuals. At times, the individuals are willing participants who “opt in” to the data collection by signing up, registering, enrolling, creating an account, or otherwise willingly agreeing to participate in the data collection. At other times, the individuals are unwitting subjects of data collection. Further techniques are legislative, such as a government requiring citizens to obtain a registration number, and to set up an account to use that number for interaction with government agencies, law enforcement, emergency services, and others. Still other data collection techniques are more subtle or are even completely hidden, such as tracking purchase histories, website visits, button clicks, and menu choices. Sadly, data can and has also been collected by theft. Irrespective of the techniques used for the data collection, the collected data is highly valuable to the organizations if it is processed rapidly and accurately.

### SUMMARY

Datasets of vast quantities are processed by organizations in support of critical organizational goals, missions, and objectives. The dataset processing is accomplished by submitting “processing jobs”, where the processing jobs load data from storage, manipulate the data using processors, and store the data, among many other operations. The processing jobs that are performed are often critical to organizational survival. Typical data processing jobs include generating invoices for accounts receivable; processing payments for accounts payable; running payroll for full time, part time, and contracted employees; analyzing research data; or training a neural network for machine learning. These processing jobs are highly complex and involve many data handling tasks. The tasks can include loading and storing various datasets, accessing processing elements and systems, executing data processing on the processing elements and systems, and so on. The tasks themselves include multiple steps or subtasks, which themselves can be highly complex. The subtasks can be used to handle specific jobs such as loading or reading certain datasets from storage, performing arithmetic and logic computations and other data manipulations, storing or writing the data back to storage, handling inter-subtask communication such as data transfers and control, and so on. The datasets that are accessed are vast and can easily overwhelm processing architectures that are either ill suited to the processing tasks or based on inflexible architectures. Instead, arrays of elements can be used for processing the tasks and subtasks, thereby significantly improving task processing efficiency and throughput. The arrays include compute elements, multiplier elements, registers, caches, buffers, controllers, decompressors, arithmetic logic units (ALUs), storage elements, and other components which can communicate among themselves.

Parallel processing is accomplished based on parallel processing with hazard detection and store probes. An array of compute elements is accessed, wherein each compute element within the array of compute elements is known to a compiler and is coupled to its neighboring compute elements within the array of compute elements. Control for the compute elements is provided on a cycle-by-cycle basis, wherein control is enabled by a stream of wide control words generated by the compiler. Data to be stored by the array of compute elements is managed, wherein the data to be stored is targeted to a data cache coupled to the array of compute elements, and wherein the managing includes detecting and mitigating memory hazards. Pending data cache accesses are examined for hazards, wherein the examining comprises a store probe. Store data is committed to the data cache, wherein the committing is based on a result of the store probe.

A processor-implemented method for parallel processing is disclosed comprising: accessing an array of compute elements, wherein each compute element within the array of compute elements is known to a compiler and is coupled to its neighboring compute elements within the array of compute elements; providing control for the compute elements on a cycle-by-cycle basis, wherein control is enabled by a stream of wide control words generated by the compiler; managing data to be stored by the array of compute elements, wherein the data to be stored is targeted to a data cache coupled to the array of compute elements, and wherein the managing includes detecting and mitigating memory hazards; examining pending data cache accesses for hazards, wherein the examining comprises a store probe; and committing store data to the data cache, wherein the committing is based on a result of the store probe. Some embodiments comprise coupling access buffers between the array of compute elements and the data cache. In embodiments, the access buffers are coupled to the array of compute elements through a crossbar switch. In embodiments, the pending data cache accesses are examined in the access buffer. And in embodiments, the examining comprises interrogating the access buffer for pending load or store addresses.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for parallel processing hazard detection and store probes.

FIG. 2 is a flow diagram for access buffer usage.

FIG. 3 is a system block diagram showing hazard detection and mitigation.

FIG. 4 is a system block diagram for a highly parallel architecture with a shallow pipeline.

FIG. 5 shows compute element array detail.

FIG. 6 is a system block diagram for compiler interactions.

FIG. 7 shows branch handling for hazard detection store probes.

FIG. 8 is a system diagram for parallel processing using hazard detection and store probes.

### DETAILED DESCRIPTION

Techniques for parallel processing with hazard detection and store probes are disclosed. A hazard occurs when a load operation and a store operation attempt to access the same memory address at substantially the same time. Further hazards can occur when load and store operations arrive too early or too late. While load operations that access the same address can be allowed because the contents at the location remain unchanged, load operations and store operations that attempt the access the same address at substantially the same time create a race condition or hazard. Depending on the execution order of the load and store operations at the same memory address, valid data may be overwritten before it can be loaded, old or invalid data may be loaded before the new data can be written, and so on. These critical timing issues can be difficult for a compiler to control at compile time because the processing speed of the array is dependent upon the number of tasks, subtasks, etc. that are executing at a given time, such as within an architectural cycle. Execution of memory access operations is further dependent on an amount of data that is in transit between storage and compute elements, etc. The data can transit a bus, a crossbar switch, etc. These difficulties arise because operation execution times and memory access operation speeds are variable and therefore unknowable to the compiler at compile time. Instead, the compiler can provide precedence information which can be used to detect hazards, and to hold or delay data promotion (e.g., load, store, and transfer operations), thereby mitigating the detected hazard.

Wide control words that are generated by a compiler are provided by a compiler to the array. The wide control words are used to control elements within an array of compute elements on a cycle-by-cycle basis. The wide control words contain precedence information that is used to tag memory access operations performed by operations associated with the control words. The tagging is provided by the compiler at compile time. The memory access operations can be monitored. The monitoring can be accomplished using a control element associated with the array of compute elements. The monitoring the memory access operations is based on two factors. The factors can include the precedence information and a number of architectural cycles of the cycle-by-cycle basis. The monitoring enables the holding of memory access data before the memory access data is promoted. Data promotion can include storing the data to memory, loading the data into the array, etc. In addition to the monitoring, data to be stored by the array of compute elements is managed. The data to be stored is targeted to a data cache, where the data cache can include a multilevel cache. The data to be stored is generated by one or more compute elements within the array of compute elements. The data cache is coupled to the array of compute elements. The data cache can be further coupled to access buffers, a crossbar switch, and so on. The managing includes detecting and mitigating data cache hazards.

In order for tasks, subtasks, and so on to execute properly, particularly in a statically scheduled architecture such as an array of compute elements, one or more operations associated with the plurality of wide control words must be executed in a semantically correct operations order. That is, the memory access load and store operations occur in an order that supports the execution of the tasks, subtasks, and so on. If the memory load and store operations do not occur in the proper order, then invalid data is loaded, stored, or processed. Another consequence of “out-of-order” memory access load and store operations is that the execution of the tasks, subtasks, etc., must be halted or suspended until valid data is available, thus increasing execution time. The monitoring and tagging of the memory access operations discussed above enables hardware ordering of memory access loads to the array of compute elements and memory access stores from the array of compute elements. That is, the loads and stores can be controlled locally, in hardware, by one or more control elements associated with or within the array of compute elements. The controlling in hardware is accomplished without compiler involvement beyond the compiler providing the plurality of control words that include precedence information. The precedence information includes intra-control word precedence and/or inter-control word precedence. The intra-control word precedence and/or inter-control word precedence can be used to locally schedule and control the memory access operations.

The array of elements is scheduled (e.g., configured) and operated by providing control to the array of elements on a cycle-by-cycle basis. The control of the array is accomplished by providing a stream of control words generated by a compiler. The control words comprise one or more operations that are executed by the elements within the array. The control words within the stream of control words can include wide control words generated by the compiler. The control words are used to configure the elements within the array, to control the flow or transfer of data, and to manage the processing of the tasks and subtasks. The compiler provides static scheduling for the array of compute elements in order to configure the array. Further, the arrays can be configured in a topology that is best suited to the given task processing. The topologies into which the arrays can be configured include a systolic, a vector, a cyclic, a spatial, a streaming, or a Very Long Instruction Word (VLIW) topology, among others. The topologies can include a topology that enables machine learning functionality.

The control words can be compressed to reduce control word storage requirements. Memory access operations associated with the control words can be tagged with precedence information. The tagging is contained in the control words, and the tagging is provided by the compiler at compile time. Data to be stored by the array of compute elements is managed. The data is targeted to a data cache coupled to the array of compute elements. The managing can be used to detect and mitigate data cache hazards, which are more generally known and characterized as “memory hazards”, such as write-after-read conflicts, read-after-write conflicts, and write-after-write conflicts. Pending data cache accesses are examined for hazards, where the examining includes a store probe. The examining can include interrogating the access buffer for pending load and store addresses. The interrogating compares a store probe address to the pending load or store addresses. A match of the store probe address to the pending load and store addresses can indicate a hazard. Store data can be committed to the data cache, where the committing is based on a result of the store probe. A result of the store probe indicating no hazard detection enables data transfer from the access buffers to the array of compute elements or from the array of compute elements to the access buffers. Otherwise, the data to be stored can be held in the access buffers prior to committing the data to the data cache. The holding enables identifying hazardous loads and stores and mitigating hazardous loads and stores prior to committing the data.

The loading data from memory includes accessing an address within memory and loading the contents into a load buffer prior to loading the data for one or more compute elements within the array. Similarly, storing data to memory includes placing the store data into an access buffer prior to storing the data to an address within memory such as the data cache. The load buffer and the access buffer can be used to hold data prior to loading into the array or storing into memory, respectively. The load buffer and the store buffer can accumulate data, retime loading data and storing data transfers, and so on. Since the load operations and the store operations access one or more addresses in the memory, hazards can be identified by comparing load and store addresses. The identifying hazards can be based on memory access hazard conditions that include write-after-read, read-after-write, and write-after-write conflicts. Since the memory access data is stored in access buffers prior to being released or committed to the memory, the identifying hazardous loads and stores can be accomplished by examining pending data cache accesses for hazards. The examining can be accomplished by an access probe, where the access probe compares load and store addresses to contents of an access buffer. The comparing can further include the precedence information. The hazards can be avoided by delaying the committing or holding of data to the access buffer and/or the releasing of data from the access buffer. The holding can be based on one or more cycles. The identifying a hazard enables hazard mitigation. Since the load data or store data requested by a memory access operation may still reside in the access buffer, the requested data can be accessed in the access buffer using a forwarding technique. Thus, the hazard mitigation can include load-to-store forwarding, store-to-load forwarding, and store-to-store forwarding.

Data manipulations are performed on an array of compute elements. The compute elements within the array can be implemented with central processing units (CPUs), graphics processing units (GPUs), application specific integrated circuits (ASICs), field programmable gate arrays (FPGAs), processing cores, or other processing components or combinations of processing components. The compute elements can include heterogeneous processors, homogeneous processors, processor cores within an integrated circuit or chip, etc. The compute elements can be coupled to local storage which can include local memory elements, register files, scratchpad storage, cache storage, etc. The scratchpad storage can serve as a “level 0” (L0) cache. The cache, which can include a hierarchical cache such as a level 1 (L1), a level 2 (L2), and a level 3 (L3) cache working together, can be used for storing data such as intermediate results, compressed control words, coalesced control words, decompressed control words, relevant portions of a control word, and the like. The cache can store data produced by a taken branch path, where the taken branch path is determined by a branch decision. The decompressed control word is used to control one or more compute elements within the array of compute elements. Multiple layers of the two-dimensional (2D) array of compute elements can be “stacked” to comprise a three-dimensional array of compute elements.

The tasks, subtasks, etc., that are associated with processing operations are generated by a compiler. The compiler can include a general-purpose compiler, a hardware description-based compiler, a compiler written or “tuned” for the array of compute elements, a constraint-based compiler, a satisfiability-based compiler (SAT solver), and so on. Control is provided to the hardware in the form of wide control words on a cycle-by-cycle basis, where one or more control words are generated by the compiler. The control words can include wide microcode control words. The length of a microcode control word can be adjusted by compressing the control word. The compressing can be accomplished by recognizing situations where a compute element is unneeded by a task. Thus, control bits within the control word associated with the unneeded compute elements are not required for that compute element. Other compression techniques can also be applied. The control words can be used to route data, to set up operations to be performed by the compute elements, to idle individual compute elements or rows and/or columns of compute elements, etc. The compiled microcode control words associated with the compute elements are distributed to the compute elements. The compute elements are controlled by a control unit which decompresses the control words. The decompressed control words enable processing by the compute elements. The task processing is enabled by executing the one or more control words. In order to accelerate the execution of tasks, to reduce or eliminate stalling for the array of compute elements, and so on, copies of data can be broadcast to a plurality of physical register files comprising 2R1 W memory elements. The register files can be distributed across the 2D array of compute elements.

Parallel processing is accomplished using hazard detection and store probe techniques. The task processing can include data manipulation. An array of compute elements is accessed. The compute elements can include computation elements, processors, or cores within an integrated circuit; processors or cores within an application specific integrated circuit (ASIC); cores programmed within a programmable device such as a field programmable gate array (FPGA); and so on. The compute elements can include homogeneous or heterogeneous processors. Each compute element within the array of compute elements is known to a compiler. The compiler, which can include a general-purpose compiler, a hardware-oriented compiler, or a compiler specific to the compute elements, can compile code for execution on the compute elements. Each compute element is coupled to its neighboring compute elements within the array of compute elements. The coupling of the compute elements enables data communication between and among compute elements. Thus, the compiler can control data flow between and among the compute elements and can also control data commitment to memory outside of the array.

Control for the compute elements is provided on a cycle-by-cycle basis. A cycle can include a clock cycle, an architectural cycle, a system cycle, etc. The control is enabled by a stream of wide control words generated by the compiler. The control words can configure compute elements within an array of compute elements. The control words can include one or more operations that can be executed by the compute elements, where the operations can include memory access operations. Data to be stored by the array of compute elements can be managed. The data to be stored can be targeted to a data cache, where the data cache can be coupled to the array of compute elements. The managing can include detecting and mitigating memory hazards. The memory access operations further can be tagged with precedence information. The tagging is contained in the control words, and the tagging is provided by the compiler at compile time. The stream of wide control words generated by the compiler provides direct, fine-grained control of the array of compute elements. The fine-grained control can include control of individual compute elements, memory elements, control elements, etc. The memory store access operations can be further tagged with a unique precedence tag. The unique precedence tag can be based on a “cycle count” during which the memory store operation needs to occur. The precedence information enables hardware ordering of memory access loads to the array of compute elements and memory access stores from the array of compute elements. The ordering can consider memory access delays, data transfer times, and so on that are unknown to the compiler at compile time. The precedence information provides semantically correct operation ordering. The semantically correct operation ordering enables successful execution of operations associated with tasks and subtasks. The memory access operations are monitored, wherein the monitoring is based on the precedence information and a number of architectural cycles of the cycle-by-cycle basis. The monitoring can be used to determine whether valid data is available for loading or storing during a given cycle. If the data is not available during the cycle or might be overwritten during the cycle, then an access hazard can occur. Pending data cache accesses can be examined for hazards. The examining can include interrogating the access buffer for load or store addresses. The interrogating compares a store probe address to the pending load and store addresses in the access buffer. Memory access data can be held before promotion, based on the monitoring. The holding can be used to mitigate hazards such as write-after-read, read-after-write, and write-after-write conflicts.

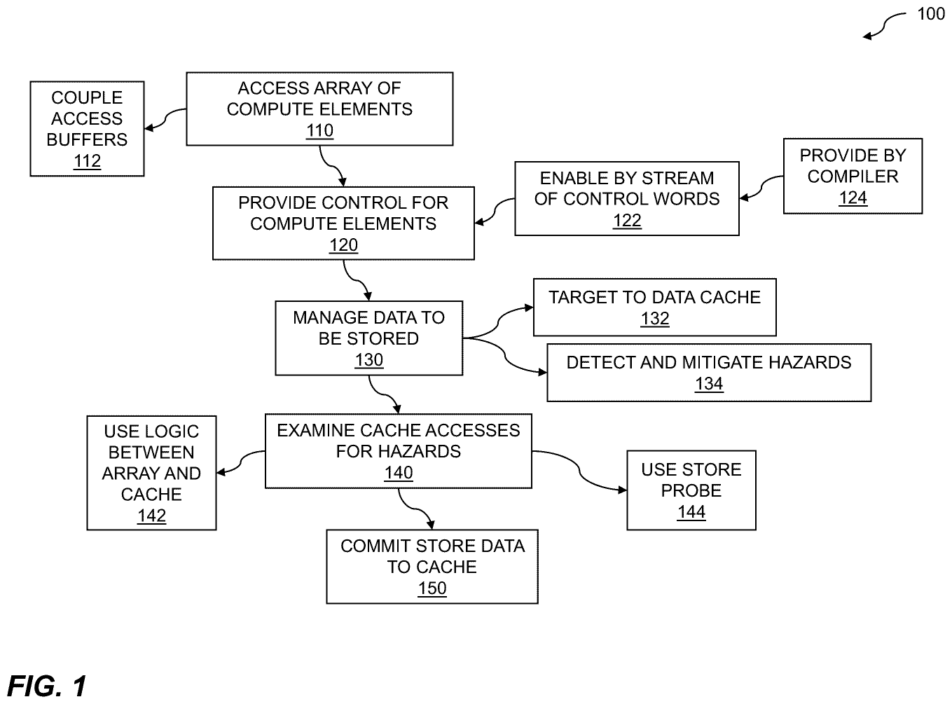

FIG. 1 is a flow diagram for parallel processing hazard detection and store probes. Groupings of compute elements (CEs), such as CEs assembled within an array of CEs, can be configured to execute a variety of operations associated with data processing. The operations can be based on tasks, and on subtasks that are associated with the tasks. The array can further interface with other elements such as controllers, storage elements, ALUs, memory management units (MMUs), GPUs, multiplier elements, and so on. The operations can accomplish a variety of processing objectives such as application processing, data manipulation, data analysis, and so on. The operations can manipulate a variety of data types including integer, real, floating-point, and character data types; vectors and matrices; tensors; etc. Control is provided to the array of compute elements on a cycle-by-cycle basis, where the control is based on wide control words generated by a compiler. The control words, which can include microcode control words, enable or idle various compute elements; provide data; route results between or among CEs, caches, and storage; and the like. The control enables compute element operation, memory access precedence, etc. Compute element operation and memory access precedence enable the hardware to properly sequence data provision and compute element results. The control enables execution of a compiled program on the array of compute elements.

The flow 100 includes accessing an array 110 of compute elements, wherein each compute element within the array of compute elements is known to a compiler and is coupled to its neighboring compute elements within the array of compute elements. The compute elements can be based on a variety of types of processors. The compute elements or CEs can include central processing units (CPUs), graphics processing units (GPUs), processors or processing cores within application specific integrated circuits (ASICs), processing cores programmed within field programmable gate arrays (FPGAs), and so on. In embodiments, compute elements within the array of compute elements have identical functionality. The compute elements can include heterogeneous compute resources, where the heterogeneous compute resources may or may not be colocated within a single integrated circuit or chip. The compute elements can be configured in a topology, where the topology can be built into the array, programmed or configured within the array, etc. In embodiments, the array of compute elements is configured by a control word that can implement a topology. The topology that can be implemented can include one or more of a systolic, a vector, a cyclic, a spatial, a streaming, or a Very Long Instruction Word (VLIW) topology. In embodiments, the array of compute elements can include a two-dimensional (2D) array of compute elements. More than one 2D array of compute elements can be accessed. Two or more arrays of compute elements can be colocated on an integrated circuit or chip, on multiple chips, and the like. In embodiments, two or more arrays of compute elements can be stacked to form a three-dimensional (3D) array. The stacking of the arrays of compute elements can be accomplished using a variety of techniques. In embodiments, the three-dimensional (3D) array can be physically stacked. The 3D array can comprise a 3D integrated circuit. In other embodiments, the three-dimensional array is logically stacked. The logical stacking can include configuring two or more arrays of compute elements to operate as if they were physically stacked. The flow 100 further includes coupling access buffers 112 between the array of compute elements and the data cache. The access buffers can be used to hold data to be stored in the data cache. The data within the access buffers can be generated by one or more compute elements within the array of compute elements. In embodiments, the access buffers can be coupled to the array of compute elements through a crossbar switch. The crossbar switch can enable connectivity between compute elements within the array of compute elements and any of the access buffers.

The compute elements can further include a topology suited to machine learning computation. A topology for machine learning can include supervised learning, unsupervised learning, reinforcement learning, and other machine learning topologies. A topology for machine learning can include an artificial neural network topology. The compute elements can be coupled to other elements within the array of CEs. In embodiments, the coupling of the compute elements can enable one or more further topologies. The other elements to which the CEs can be coupled can include storage elements such as a scratchpad memory, one or more levels of cache storage, control units, multiplier units, address generator units for generating load (LD) and store (ST) addresses, buffers, register files, and so on. The compiler to which each compute element is known can include a C, C++, or Python compiler. The compiler to which each compute element is known can include a compiler written especially for the array of compute elements. The coupling of each CE to its neighboring CEs enables clustering of compute resources; sharing of array elements such as cache elements, multiplier elements, ALU elements, or control elements; communication between or among neighboring CEs; and the like.

The flow 100 includes providing control 120 for the compute elements on a cycle-by-cycle basis. The controlling the array can include configuration of elements such as compute elements within the array; loading and storing data; routing data to, from, and among compute elements; and so on. A cycle can include a clock cycle, an architectural cycle, a system cycle, a self-timed cycle, and the like. In the flow 100, the control is enabled by a stream of control words 122 generated and is provided by the compiler 124. The control words can include microcode control words, compressed control words, encoded control words, and the like. The “wideness” or width of the control words allows a plurality of compute elements within the array of compute elements to be controlled by a single wide control word. For example, an entire row of compute elements can be controlled by that wide control word. In embodiments, the stream of wide control words can include variable length control words generated by the compiler. The control words can be decompressed, used, etc., to configure the compute elements and other elements within the array; to enable or disable individual compute elements, rows, and/or columns of compute elements; to load and store data; to route data to, from, and among compute elements; and so on. In other embodiments, the stream of wide control words generated by the compiler can provide direct, fine-grained control of the array of compute elements. The fine-grained control of the compute elements can include enabling or idling individual compute elements, enabling or idling rows or columns of compute elements, etc.

Data processing that can be performed by the array of compute elements can be accomplished by executing tasks, subtasks, and so on. The tasks and subtasks can be represented by control words, where the control words configure and control compute elements within the array of compute elements. The control words comprise one or more operations, where the operations can include data load and store operations; data manipulation operations such as arithmetic, logical, matrix, and tensor operations; and so on. The control words can be compressed by the compiler, by a compressor, and the like. The plurality of wide control words enables compute element operation. Compute element operations can include arithmetic operations such as addition, subtraction, multiplication, and division; logical operations such as AND, OR, NAND, NOR, XOR, XNOR, and NOT; matrix operations such as dot product and cross product operations; tensor operations such as tensor product, inner tensor product, and outer tensor product; etc. The control words can comprise one or more fields. The fields can include one or more of an operation, a tag, data, and so on. In embodiments, a field of a control word in the plurality of control words can signify a “repeat last operation” control word. The repeat last operation control word can include a number of operations to repeat, a number of times to repeat the operations, etc. The plurality of control words enables compute element memory access. Memory access can include access to local storage such as one or more register files or scratchpad storage, memory coupled to a compute element, storage shared by two or more compute elements, cache memory such as level 1 (L1), level 2 (L2), and level 3 (L3) cache memory, a memory system, etc. The memory access can include loading data, storing data, and the like.

In embodiments, the array of compute elements can be controlled on a cycle-by-cycle basis. The controlling the array can include configuration of elements such as compute elements within the array; loading and storing data; routing data to, from, and among compute elements; and so on. A cycle can include a clock cycle, an architectural cycle, a system cycle, a self-timed cycle, and the like. In embodiments, the stream of control words can include compressed control words, variable length control words, etc. The control words can further include wide compressed control words. The control words can be provided as a stream of control words to the array. The control words can include microcode control words, compressed control words, encoded control words, and the like. The width of the control words allows a plurality of compute elements within the array of compute elements to be controlled by a single wide control word. For example, an entire row of compute elements can be controlled by that wide control word. The control words can be decompressed, used, etc., to configure the compute elements and other elements within the array; to enable or disable individual compute elements, rows, and/or columns of compute elements; to load and store data; to route data to, from, and among compute elements; and so on.

Various types of compilers can be used to generate the stream of wide control words. The compiler which generates the wide control words can include a general-purpose compiler such as a C, C++, Java, or Python compiler; a hardware description language compiler such as a VHDL or Verilog compiler; a compiler written for the array of compute elements; and the like. In embodiments, the control words comprise compressed control words, variable length control words, and the like. In embodiments, the stream of control words generated by the compiler can provide direct fine-grained control of the 2D array of compute elements. The compiler can be used to map functionality to the array of compute elements. In embodiments, the compiler can map machine learning functionality to the array of compute elements. The machine learning can be based on a machine learning (ML) network, a deep learning (DL) network, a support vector machine (SVM), etc. In embodiments, the machine learning functionality can include a neural network (NN) implementation. The neural network implementation can include a plurality of layers, where the layers can include one or more of input layers, hidden layers, output layers, and the like. A control word generated by the compiler can be used to configure one or more CEs, to enable data to flow to or from the CE, to configure the CE to perform an operation, and so on. Depending on the type and size of a task that is compiled to control the array of compute elements, one or more of the CEs can be controlled, while other CEs are unneeded by the particular task. A CE that is unneeded can be marked in the control word as unneeded. An unneeded CE requires no data and no control word. In embodiments, the unneeded compute element can be controlled by a single bit. In other embodiments, a single bit can control an entire row of CEs by instructing hardware to generate idle signals for each CE in the row. The single bit can be set for “unneeded”, reset for “needed”, or set for a similar usage of the bit to indicate when a particular CE is unneeded by a task.

The stream of wide control words that is generated by the compiler can include a conditionality such as a branch. The branch can include a conditional branch, an unconditional branch, etc. Compressed control words can be decompressed by a decompressor logic block that decompresses words from a compressed control word cache on their way to the array. In embodiments, a set of operations associated with one or more compressed control words can include a spatial allocation of subtasks on one or more compute elements within the array of compute elements. In other embodiments, the set of operations can enable multiple, simultaneous programming loop instances circulating within the array of compute elements. The multiple programming loop instances can include multiple instances of the same programming loop, multiple programming loops, etc.

The flow 100 includes managing data 130 to be stored by the array of compute elements. The managing data can include obtaining data from one or more compute elements within the array of compute elements. The data that can be obtained can be stored in buffers. The managing can include loading data obtained from the one or more compute elements into one or more access buffers. In embodiments, the access buffers hold load data for the array of compute elements. The data access buffers can include 2R2 W buffers. The 2R2 W buffers can enable two read operations and two write operations contemporaneously without the read and write operations interfering with one another. In embodiments, the access buffers can hold data awaiting commitment to the data cache. In other embodiments, the access buffers can be coupled between the array of compute elements and the data cache. Other components can be coupled between the data cache, the access buffers, and the array of compute elements. In embodiments, one or more access buffers can be further coupled to a crossbar switch. In the flow 100, the data to be stored is targeted to a data cache 132 coupled to the array of compute elements. The data cache can include a single level cache, a multilevel cache, one or more shared levels of cache, and so on. The data cache can be colocated with the array of compute elements within a single integrated circuit; coupled to the array; accessible to the array through an interconnect, a bus, or a network; and so on. The contents of the data cache can be targeted to a memory system. The data that is managed can include data targeted to one or more addresses within the data cache. The addresses can include a block of data within the data cache.

In embodiments, the load data is being held for hazard detection and mitigation. In the flow 100, the managing includes detecting and mitigating memory hazards 134. More than one compute element can process data targeted to an address, and thus storage, or memory, access hazards can occur. The memory access hazards can be associated with the data cache. Further embodiments can include identifying hazardous loads and stores by comparing load and store addresses to addresses of contents of the access buffer. The identifying hazardous loads and stores enables proper execution of tasks, subtasks, and so on by identifying load-store timing conflicts. In embodiments, hazardous loads and stores can include write-after-read conflicts, read-after-write conflicts, and write-after-write conflicts. The managing data to be stored can include hazard mitigation. In embodiments, the identifying enables hazard mitigation. The hazard mitigation can be accomplished using a variety of techniques. In embodiments, the hazard mitigation can include load-to-store forwarding, store-to-load forwarding, and store-to-store forwarding. The forwarding techniques are based on accessing data within one or more access buffers rather than from the data cache or the memory. Returning to comparing load and store addresses to contents of an access buffer, embodiments include performing load/store forwarding. The load/store forwarding can provide data to a load request from the access buffer rather than from the cache memory since the data in the cache memory has yet to be updated. In embodiments, the identifying enables hazard mitigation. The identifying can include identifying load hazards and store hazards. In embodiments, the hazard mitigation includes load-to-store forwarding, store-to-load forwarding, and store-to-store forwarding.

The flow 100 includes examining 140 pending data cache accesses for hazards, wherein the examining comprises a store probe 144. The data cache accesses are generated by one or more compute elements within the array of compute elements. The compute elements can be executing operations associated with one or more tasks, subtasks, and so on. The tasks and subtasks can be associated with a variety of types of processing such as audio and image processing, artificial intelligence (AI), and so on. The executing operations can obtain data for processing, can process the data, and can return the data to storage such as the data cache. The data cache accesses that are associated with the executing operations can include access to one or more substantially similar addresses within the data cache. These accesses must be ordered correctly to avoid hazards such as processing old data, overwriting valid data, and so on. The examining pending data cache accesses can be accomplished by examining a collection of pending accesses. In embodiments, the pending data cache accesses can be examined in the access buffer. Since more than one access buffer can be coupled to the data cache, the examining can be performed within an access buffer, between access buffers, and so on.

In embodiments, the examining can include interrogating the access buffer for pending load or store addresses. The load or store address can be associated with the pending data cache accesses. When matching addresses are found between or among the pending data cache accesses, then further techniques can be applied. The further techniques can include determining which duplicate addresses are found; whether the pending accesses are read access, write accesses, or both read and write accesses; and so on. In embodiments, the interrogating can compare a store probe address to the pending load or store addresses. The store probe can be associated with a pending access request to determine whether the pending access request can be granted, or the access request must wait. In other embodiments, the store probe address is not associated with a data field, but simply comprises an address. In the flow 100, the examining can occur in logic 142 coupling the array of compute elements to the data cache. The logic can include a compute element within the array of compute elements, logic associated with one or more access caches, and the like.

The examining pending data cache accesses for hazards can include identifying the hazards. In embodiments, the identifying can enable hazard mitigation. The identifying the load and store hazards can include characterizing the hazards. In embodiments, the hazardous loads and stores can include write-after-read conflicts, read-after-write conflicts, and write-after-write conflicts. Discussed previously, the identifying can compare load and store addresses to addresses of contents of the access buffer, where the comparing identifies potential access to the same address. Additional techniques can be used to determine not only that potential accesses to the same address are identified, but how to mitigate those hazards. Mitigating the hazards can include ordering the pending data cache accesses to avoid hazards, to resolve hazards, etc. Further embodiments can include precedence information in the comparison. The precedence information can be based on a rank, an order, a tag, and so on. In embodiments, the pending data cache access can be tagged with precedence information. The tagging can be contained in the control words provided by the compiler. The tagging can include a fixed number of bits, bytes, etc. within a control word. The bits can comprise a field within the control word. The tagging field can include a variable number of bits, where the number of bits can be based on a control word, a compressed control word, etc. In embodiments, the precedence information can include intra-control word precedence and/or inter-control word precedence. Precedence tags can be provided at compile time and later augmented at run time by the hardware, depending on program behavior. The precedence information associated with the tagging can include a priority, dependencies within a control word (intra-control word), dependencies between control words (inter-control words), and the like. The tagging can include an execution order. The execution can be associated with operations such as memory access operations associated with the stream of control words. The tagging can be provided by the compiler at compile time. Recall that the compiler generates the stream of wide control words. The control words configure the array of compute elements to execute tasks and subtasks. The compiler considers inputs to a given task; subtasks, if any, associated with the tasks; etc. The compiler further considers execution order of tasks and subtasks, data and control dependencies between tasks and between subtasks, branches within the code, and so on. The compiler then generates the stream of wide control words based the execution orders, data dependencies, etc.

The precedence information generated by the compiler at compile time is critical to proper processing of tasks and subtasks. The precedence information can describe load operations and store operations that access memory or cache, such as a memory cache. In embodiments, the memory cache can include a data cache for the array of compute elements. As operations associated with the tasks and subtasks are executed, memory access times can vary depending on the number of memory access operations which are requested in a given cycle, amounts of data loaded and stored, and so on. In embodiments, the data cache can have an access time that is unknown to the compiler. Discussed throughout, data cache accesses can transit a switch such as crossbar switch as data is transferred among the data cache memory, buffers such as access buffers and load buffers, and the array of compute elements. In embodiments, a delay for the transferring data through the crossbar switch is unknown to the compiler. In embodiments, the precedence information can enable hardware ordering of data cache access loads to the array of compute elements and data cache access stores from the array of compute elements. The hardware ordering can order execution of data cache access operations such as data cache load and store operations based on the data cache access times and the crossbar switch transit times that occur within cycles of the cycle-by-cycle basis. The hardware ordering can include changing a control flow. The control flow can comprise an alternate path that performs access operations serially, for example, such that hazards are avoided.

The flow 100 includes committing store data 150 to the data cache, wherein the committing is based on a result of the store probe. The committing data can include obtaining data from one or more access buffers and storing that information into one or more addresses in the data cache. The committing the data can be based on an occurrence of one or more conditions, factors, and so on. In embodiments, a result of the store probe indicating no hazard detection can enable data transfer from the access buffers to the array of compute elements. Similarly, a result of the store probe can enable data transfer from the access buffers to the data cache. In other embodiments, a result of the store probe indicating no pending data awaiting commitment can enable data transfer from the array of compute elements to the access buffers. Transfer of data between the compute elements and the access buffers can be accomplished by transiting the crossbar switch. When pending data awaiting commitment is indicated, other data handling techniques can be applied. Embodiments can further include holding data or delaying the promotion of data to the access buffer, and/or the releasing of data from the access buffer. The delaying can include an amount of time, a number of cycles such as architectural cycles, and so on. In embodiments, the delaying can avoid hazards. Mentioned previously and throughout, further techniques can be used in addition to or other than delaying. In embodiments, the avoiding hazards can be based on a comparative precedence value. In a usage example, potential hazards can be identified. To resolve the hazards, “higher” precedence accesses can be enabled while “lower” precedence accesses are held until the higher precedence accesses can be completed. Thus, the precedence information informs the hardware how to properly execute accesses temporally in order to ensure program execution correctness.

The holding can be based on retaining store data, such as data associated with pending data cache accesses, in storage within the array of compute elements. The holding can be based on an amount of time, a number of cycles, and so on. The holding can be based on the precedence information. The holding can be accomplished using other storage such as a scratchpad memory. In embodiments, the holding can be accomplished using the access buffers coupled between the data cache and the array of compute elements. Discussed previously and throughout, the access buffers can be coupled to a cache such as a data cache. Data produced by operations executing on the array of compute elements can transfer the data to the access buffers. In embodiments, the transferring can be accomplished using the crossbar switch. In embodiments, the holding can prevent premature data commitment into or out of the data cache. Premature data commitment can cause any of the hazards described previously. The premature data commitment can cause data to arrive too early or data to arrive too late, thereby resulting in hazards such as a write-after-read, read-after-write, and write-after-write hazards.

Operations can be executed in parallel or in a sequential, or sequenced, fashion. The operations can include arithmetic, logic, matrix, tensor, and other data manipulation operations. The operations can further include memory access operations. The operations can be associated with control words within the stream of wide control words generated by the compiler. In embodiments, the precedence information provides semantically correct operation ordering. The semantically correct operation ordering can include executing independent operations in parallel. Execution of dependent operations can include executing operations in series, executing operations in a combination of parallel and series operations, etc.

Further embodiments include decompressing a stream of compressed control words. The decompressed control words can comprise one or more operations, where the operations can be executed by one or more compute elements within the array of compute elements. The decompressing the compressed control words can be accomplished using a decompressor element. The decompressor element can be coupled to the array of compute elements. In embodiments, the decompressing by a decompressor operates on compressed control words that can be ordered before they are presented to the array of compute elements. The presented compressed control words that were decompressed can be executed by one or more compute elements. Further embodiments include executing operations within the array of compute elements using the plurality of compressed control words that were decompressed. The executing operations can include configuring compute elements, loading data, processing data, storing data, generating control signals, and so on. The executing the operations within the array can be accomplished using a variety of processing techniques such as sequential execution techniques, parallel processing techniques, etc.

The control words that are generated by the compiler can include a conditionality. In embodiments, the control words include branch operations. Code, which can include code associated with an application such as image processing, audio processing, and so on, can include conditions which can cause execution of a sequence of code to transfer to a different sequence of code. The conditionality can be based on evaluating an expression such as a Boolean or arithmetic expression. In embodiments, the conditionality can determine code jumps. The code jumps can include conditional jumps as just described, or unconditional jumps such as a jump to halt, exit, or terminate an operation. The conditionality can be determined within the array of elements. In embodiments, the conditionality can be established by a control unit. In order to establish conditionality by the control unit, the control unit can operate on a control word provided to the control unit. Further embodiments include suppressing memory access stores for untaken branch paths. In parallel processing techniques, each path or side of a conditionality such as a branch can begin execution prior to the evaluating the conditionality that will decide which path to take. Once the conditionality has been decided, execution of operations associated with the taken path or side can continue. Operations associated with the untaken path can be suspended. Thus, any memory access stores associated with the untaken path can be suppressed because they are no longer relevant. In embodiments, the control unit can operate on decompressed control words. The control words can be a decompressed by a decompressor logic block that decompresses words from a compressed control word cache on their way to the array. In embodiments, the set of directions can include a spatial allocation of subtasks on one or more compute elements within the array of compute elements.

The operations that are executed by the compute elements within the array can include arithmetic operations, logical operations, matrix operations, tensor operations, and so on. The operations that are executed are contained in the control words. Discussed above, the control words can include a stream of wide control words generated by the compiler. The control words can be used to control the array of compute elements on a cycle-by-cycle basis. A cycle can include a local clock cycle, a self-timed cycle, a system cycle, and the like. In embodiments, the executing occurs on an architectural cycle basis. An architectural cycle can include a read-modify-write cycle. In embodiments, the architectural cycle basis reflects non-wall clock, compiler time. The execution can include distributed execution of operations. In embodiments, the distributed execution of operations can occur in two or more compute elements within the array of compute elements, within a grouping of compute elements, and so on. The compute elements can include independent or individual compute elements, clustered compute elements, etc. Execution of specific compute element operations can enable parallel operation processing. The parallel operation processing can include processing nodes of a graph that are independent of each other, processing independent tasks and subtasks, etc. The operations can include arithmetic, logic, array, matrix, tensor, and other operations. A given compute element can be enabled for operation execution, idled for a number of cycles when the compute element is not needed, etc. The operations that are executed can be repeated. An operation can be based on a plurality of control words.

The operation that is being executed can include data dependent operations. In embodiments, the plurality of control words includes two or more data dependent branch operations. The branch operation can include two or more branches, where a branch is selected based on an operation such as an arithmetic or logical operation. In a usage example, a branch operation can determine the outcome of an expression such as A>B. If A is greater than B, then one branch can be taken. If A is less than or equal to B, then another branch can be taken. In order to expedite execution of a branch operation, sides of the branch can be precomputed prior to datum A and datum B being available. When the data is available, the expression can be computed, and the proper branch direction can be chosen. The untaken branch data and operations can be discarded, flushed, etc. In embodiments, the two or more data dependent branch operations can require a balanced number of execution cycles. The balanced number of execution cycles can reduce or eliminate idle cycles, stalling, and the like. In embodiments, the balanced number of execution cycles is determined by the compiler. In embodiments, the generating, the customizing, and the executing can enable background memory access. The background memory access can enable a control element to access memory independently of other compute elements, a controller, etc. In embodiments, the background memory access can reduce load latency. Load latency is reduced since a compute element can access memory before the compute element exhausts the data that the compute element is processing.

The array of compute elements can accomplish autonomous operation. The autonomous operation can be based on a buffer such as an autonomous operation buffer that can be loaded with an operation that can be executed using a “fire and forget” technique, where operations are loaded in the autonomous operation buffer and the operations can be executed without further supervision by a control word. The autonomous operation of the compute element can be based on operational looping, where the operational looping is enabled without additional control word loading. The looping can be enabled based on ordering memory access operations such that memory access hazards are avoided. Note that latency associated with access by a compute element to storage can be significant and can cause operation of the compute element to stall. A compute element operation counter can be coupled to the autonomous operation buffer. The compute element operation counter can be used to control a number of times that the operations within the autonomous operation buffer are cycled through. The compute element operation counter can be used to indicate or “point to” the next operation to be provided to a compute element, a multiplier element, an ALU, or another element within the array of compute elements. In embodiments, the autonomous operation buffer and the compute element operation counter enable compute element operation execution. The compute element operation execution can include executing one or more operations, looping operations, and the like. In embodiments, the compute element operation execution involves operations not explicitly specified in a control word. Operations not explicitly specified in a control word can include low level operations, such as data transfer protocols, execution completion and other signal generation techniques, etc., within the array of compute elements.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

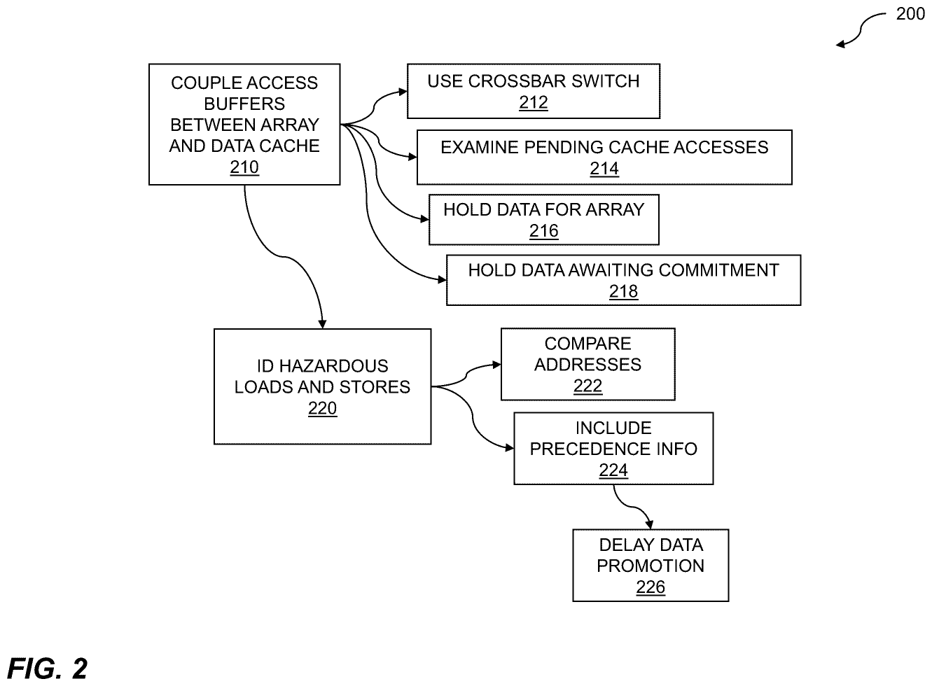

FIG. 2 is a flow diagram for access buffer usage. Operations executed on an array such as an array of compute elements can include read (load) operations, write (store) operations, read-modify-write operations, and so on. Data obtained by a load operation can be held in a load buffer prior to delivering the data to one or more compute elements with the array of compute elements. Data such as store data targeted to a cache such as a data cache can be held in an access buffer prior to committing the data to the data cache. The read-modify-write operations access memory to load data, manipulate the data, and store the manipulated data back to memory. The array of compute elements that perform the operations can be controlled using one or more control words. The control words can be generated by a compiler and can be used to configure or schedule one or more compute elements within the array. The compute elements that are scheduled can perform operations such as arithmetic, logical, matrix, or tensor operations; can access various storage or memory elements such as local cache and shared cache; and so on. The control words can include wide control words. The wide control words can include fixed length control words, variable length control words, etc. In order for the control words to be provided to and stored more efficiently in the array, the control words can be compressed. The compressing of the control words can be accomplished by the compiler. The compressed control words can be stored more efficiently since the compressed words can be shorter than the uncompressed control words.

Noted throughout, the order of memory access operations is critical to the successful execution of tasks, subtasks, and so on. The memory access operations can include access to the data cache. The data cache access operations can be tagged with precedence information. The precedence information can include a memory access order, priority, etc. The tagging can be contained in the control words and can be provided by the compiler at compile time. The data cache access operations, including load and store operations, can be monitored based on the precedence information provided by the compiler. The monitoring can also be based on a number of architectural cycles of the cycle-by-cycle basis. Data cache access data holding techniques can be used to hold the data prior to promoting or committing the data to the data cache. The holding data can prevent data cache access hazards such as an attempt to load and store data to the same address at substantially the same time. The tagging and monitoring enable parallel processing with hazard detection and store probes. An array of compute elements is accessed, wherein each compute element within the array of compute elements is known to a compiler and is coupled to its neighboring compute elements within the array of compute elements. Control for the compute elements is provided on a cycle-by-cycle basis, wherein control is enabled by a stream of wide control words generated by the compiler. Data to be stored by the array of compute elements is managed, wherein the data to be stored is targeted to a data cache coupled to the array of compute elements, and wherein the managing includes detecting and mitigating memory hazards. Pending data cache accesses are examined for hazards, wherein the examining comprises a store probe. Store data is committed to the data cache, wherein the committing is based on a result of the store probe.

The flow 200 includes coupling access buffers 210 between the array of compute elements and the data cache. The access buffers can hold data generated by one or more compute elements within the array of compute elements. The access buffers can be used to compensate or account for access latency associated with accessing the data cache. The access latency is unknown to a compiler at the time the compiler can compile code associated with tasks, subtasks, and so on. The latency is unknown to the compiler because the latency can be dependent on other operations which can be executing at the time of a data cache access, bus contention, and the like. In the flow 200, the access buffers are coupled to the array of compute elements through a crossbar switch 212. The crossbar switch can be used to couple one or more access buffers to portions of the data cache. The crossbar switch can be a further source of data cache access latency since transit times for data traversing the crossbar switch can also be dependent on bus contention, an amount of data traversing the crossbar switch, etc.

In the flow 200, the pending data cache accesses are examined 214 in the access buffer. The pending data cache accesses can be generated by one or more compute elements within the array of compute elements. The data cache accesses can include load access, store access, and so on. The pending data cache accesses can access one or more addresses within a storage element such as the data cache. Since more than one data cache access can be associated with the same address within the data cache, then the order in which the data cache accesses are performed is critical to maintaining data integrity, supporting a correct order of data processing by one or more compute elements within the array, etc. In embodiments, the examining can include interrogating the access buffer for pending load or store addresses. The interrogating can include providing a data access address to determine whether the data access address is present within the access buffer. In embodiments, the interrogating can compare a store probe address to the pending load or store addresses. Various techniques can be used to accomplish the examining, interrogating, and so on. In embodiments, the examining can occur in logic coupling the array of compute elements to the data cache. In other embodiments, the store probe address is not associated with a data field.

In the flow 200, the access buffers hold load data 216 for the array of compute elements. The access buffers can accumulate data as it is generated by one or more compute elements within the array of compute elements. The access buffers can be used to compensate for unknown latencies associated with bus contention, crossbar switch transit times, and the like. In embodiments, the load data can be held for hazard detection and mitigation. Recall that an access hazard can occur when data cache accesses are performed such that old, still valid data is overwritten prior to reading the old, valid data, if new data does not arrive in time to be read, and the like. In embodiments, the hazardous loads and stores can include write-after-read conflicts, read-after-write conflicts, and write-after-write conflicts. In the flow 200, the access buffers can hold data awaiting commitment 218 to the data cache. Discussed throughout, the holding can compensate for unknown latency times associated with a bus, the crossbar switch, etc. The holding can further compensate for differences in transfer times between compute elements and the access buffers, the access buffers and the data cache, etc. The holding can further be based on other, pending data cache accesses. The other data cache accesses can include higher priority data cache accesses, where the higher priority can be based on task and subtask order of execution, operation priority, etc. In embodiments, a result of the store probe indicating no pending data awaiting commitment can enable data transfer from the array of compute elements to the access buffers (discussed below).

The flow 200 further includes identifying hazardous loads and stores 220. Hazardous loads and stores can occur when the loads and stores occur out of order. Discussed above, a load can occur before valid data is available, a store can overwrite valid data, and so on. The identifying hazardous loads and stores and can be accomplished by examining addresses, such as addresses within the data cache, that are associated with the loads and stores. In embodiments, the identifying hazardous loads and stores can be accomplished by comparing load and store addresses 222 to addresses of contents of the access buffer. The comparing load and store addresses can be accomplished by code executing on a compute element, by logic associated with the access buffer, etc. In embodiments, the comparing can identify potential accesses to the same address. While more than one read from an address may be permissible, more than one write to the address at substantially the same time may not be. Again, the order of allowing the data cache accesses is critical. Techniques can be used to further determine an order of execution of data cache accesses. The flow 200 further includes precedence information 224 in the comparison. The precedence information can include a rank, an order, a priority, and the like. The priority can be based on a tag, where the tag can be generated by the compiler at compile time. The flow 200 further includes delaying the promotion of 226 data 226 to the access buffer and/or the releasing of data from the access buffer. The delaying the promoting or committing of data can allow higher priority or earlier order data cache accesses to complete prior to promoting or committing the data to the data cache. The delaying can be based on an amount of time, a number of cycles such as architectural cycles, etc.

Described above, the control provided by the control words can be provided on a cycle-by-cycle basis. In addition to configuring elements such as compute elements within the array of elements, the provided control can include loading and storing data; routing data to, from, and among compute elements; and so on. The control is enabled by a stream of wide control words generated by the compiler. The control words can configure the compute elements and other elements within the array; enable or disable individual compute elements or rows, and/or columns of compute elements; load and store data; route data to, from, and among compute elements; etc. The one or more control words are generated by the compiler as discussed above. The compiler can be used to map functionality to the array of compute elements. A control word generated by the compiler can be used to configure one or more CEs, to enable data to flow to or from the CE, to configure the CE to perform an operation, and so on. Depending on the type and size of a task that is compiled to control the array of compute elements, one or more of the CEs can be controlled, while other CEs are unneeded by the particular task. A CE that is unneeded can be marked in the control word as unneeded. An unneeded CE requires no data, nor is a control word portion, which can be called a control word bunch, required by it. In embodiments, the unneeded compute element can be controlled by a single bit. In other embodiments, a single bit can control an entire row of CEs by instructing hardware to generate idle signals for each CE in the row. The single bit can be set for “unneeded”, reset for “needed”, or set for a similar usage of the bit to indicate when a particular CE is unneeded by a task.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors.

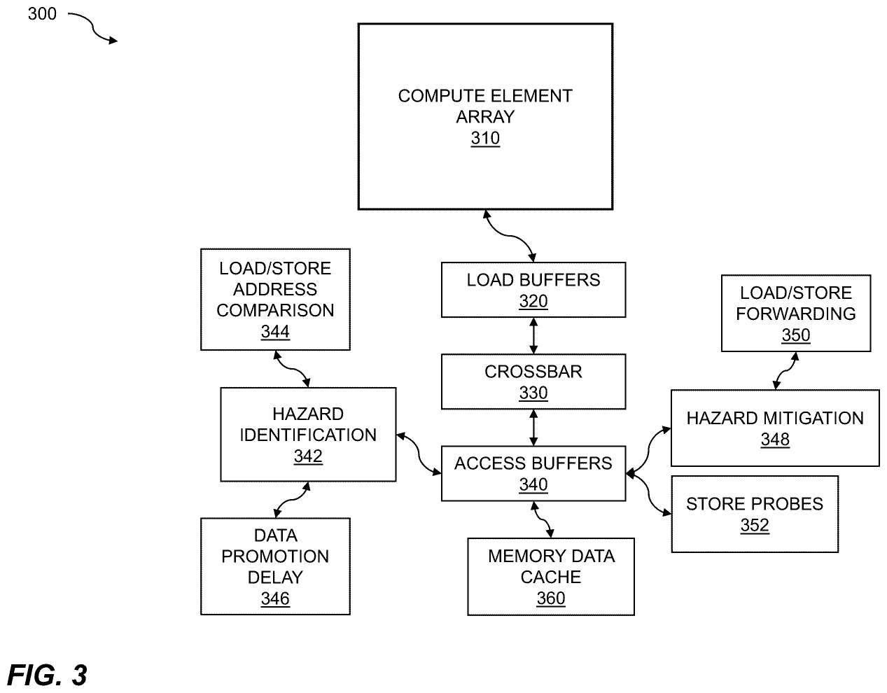

FIG. 3 is a system block diagram showing hazard detection and mitigation. The hazard detection and mitigation can be accomplished using store probes. An array of elements can be configured to process data. As discussed previously and throughout, the elements can include compute elements, processing elements, buffers, one or more levels of cache storage, system management, arithmetic logic units, multipliers, memory management units, and so on. Data can be loaded from a memory such as a cache memory into the compute elements for processing, and results of the processing can be stored back to memory. Since the array of compute elements can be configured for parallel processing applications, the order in which the data loads and the data stores are executed is critical. The data to be loaded must be valid, and the data that is stored must not overwrite valid data yet to be loaded for processing. Loading invalid data or storing data over valid data are considered memory access hazards. Various hazards can be identified by examining pending accesses to a cache such as a data cache. The examining can include a store probe. The hazards can be mitigated by monitoring memory access operations, and by holding memory access data before promotion. The memory access data that is held can be committed to the data cache based on the result of the store probe. The hazard detection and store probes enable parallel processing. An array of compute elements is accessed, wherein each compute element within the array of compute elements is known to a compiler and is coupled to its neighboring compute elements within the array of compute elements. Control for the compute elements is provided on a cycle-by-cycle basis, wherein control is enabled by a stream of wide control words generated by the compiler. Data to be stored by the array of compute elements is managed, wherein the data to be stored is targeted to a data cache coupled to the array of compute elements, and wherein the managing includes detecting and mitigating memory hazards. Pending data cache accesses are examined for hazards, wherein the examining comprises a store probe. Store data is committed to the data cache, wherein the committing is based on a result of the store probe.

Processes, tasks, subtasks, and so on can be executed on a parallel processing architecture. Some of the tasks, for example, can be executed in parallel, while others have to be properly sequenced. The sequential execution and the parallel execution of the tasks are dictated in part by the existence of or absence of data dependencies between tasks. In a usage example, a task A processes input data and produces output data that is required by task B. Thus, task A must be executed prior to executing task B. Task C, however, executes tasks that process the same input data as task A and produces output data. Thus, task C can be executed in parallel with task A. The execution of tasks can be based on memory access operations, where the memory access operations include data loads from memory, data stores to memory, and so on. If, in the example just recited, task B were to attempt to access data before task A and produced the required data, a hazard would occur. Thus, hazard detection and mitigation can be critical to successful parallel processing. In embodiments, the hazards can include write-after-read, read-after-write, and write-after-write conflicts. The hazard detection can be based on identifying memory access operations that access the same address. Precedence information associated with each memory address operation can be used to coordinate memory access operations so that valid data can be loaded, and to ensure that valid data is not corrupted by a store operation overwriting the valid data. Techniques for hazard detection and mitigation can include holding memory access data before promotion, delaying the promotion of data to the access buffer and/or the releasing of data from the access buffer, and so on.

Data can be moved between a memory such as a memory data cache, and storage elements associated with the array of compute elements. The storage elements associated with the array of compute elements can include scratchpad memory, register files, and so on. Memory access operations can include loads from memory, stores to memory, memory-to-memory transfers, etc. The storage elements can include a local storage coupled to one or more compute elements within a 2D array of compute elements, storage associated with the array, cache storage, a memory system, and so on. A load memory access operation can load control words, compressed control words, bunches of bits associated with control words, data, and the like. Memory access operations enable parallel processing using hazard detection and mitigation. An array of compute elements is accessed, wherein each compute element within the array of compute elements is known to a compiler and is coupled to its neighboring compute elements within the array of compute elements. Control for the compute elements is provided on a cycle-by-cycle basis, wherein control is enabled by a stream of wide control words generated by the compiler. Memory access operations are tagged with precedence information, wherein the tagging is contained in the control words, and wherein the tagging is provided by the compiler at compile time. Memory access operations are monitored, wherein the monitoring is based on the precedence information and a number of architectural cycles of the cycle-by-cycle basis. Memory access data is held before promotion, based on the monitoring.

The figure illustrates a block diagram 300 for hazard detection and mitigation. One or more hazards, which can be encountered during memory access operations, can result when two or more memory access operations attempt to access the same memory address. While multiple loads (reads) from an address may not create a hazard, combinations of loads and stores to the same address are problematic. Hazard detection and mitigation techniques enable memory access operations to be performed while avoiding hazards. The memory access operations include loading data from memory and storing data to memory. The data is loaded from memory to supply data to tasks, subtasks, and so on to be executed on an array. Data produced by the tasks and subtasks can be stored back to the memory. The array can include an array of compute elements 310. The array can include a two-dimensional array, stacked two-dimensional arrays, and so on. The data can be loaded or stored based on a number of bytes, words, blocks, etc.

Data movement, whether loading, storing, transferring, etc., can be accomplished using a variety of techniques. In embodiments, memory access operations can be performed outside of the array of compute elements, thereby freeing the compute elements to execute tasks, subtasks, etc. Memory access operations, such as autonomous memory operations, can preload data needed by one or more compute elements. In additional embodiments, a semi-autonomous memory copy technique can be used for transferring data. The semi-autonomous memory copy technique can be accomplished by the array of compute elements which generates source and target addresses required for the one or more data moves. The array can further generate a data size such as 8, 16, 32, or 64-bit data sizes, and a striding value. The striding value can be used to avoid overloading a column of storage components such as a cache memory. The source and target addresses, data size, and striding can be under direct control of a compiler.

The block diagram 300 can include load buffers 320. The load buffers can include two or more buffers associated with the compute element array. The buffers can be shared by the compute elements within the array, a subset of compute elements can be assigned to each buffer, etc. The load buffers can hold data targeted to one or more compute elements within the array as the data is read from a memory such as data cache memory. The load buffers can be used to accumulate an amount of data before transferring the data to one or more compute elements, to retime (e.g., hold or delay) delivery of data loaded from storage prior to data transfer to compute elements, and the like. The block diagram 300 can include a crossbar switch 330. The crossbar switch can provide selectable communication paths between buffers associated with a memory (discussed shortly below). The crossbar switch enables transit of memory access data between buffers associated with the memory and the load buffers associated with the compute elements. The crossbar switch can enable multiple data access operations within a given cycle.

The block diagram 300 can include access buffers 340. Two or more access buffers can be coupled to a memory such as data cache memory (discussed below). The access buffers can hold data such as store data produced by operations associated with tasks, subtasks, etc. The operations are executed using compute elements within the array. In embodiments, the holding can be accomplished using access buffers coupled to a memory cache. The holding can be based on monitoring memory access operations that have been tagged. The tagging can be contained in the control words, and the tagging can be provided by the compiler at compile time. The load data can be held in the access buffers prior to the data transiting the crossbar switch to the load buffers or being directed to compute elements within the array. Since there is a transit latency associated with the crossbar switch, load data can transit the crossbar switch in a number of cycles not able to be determined by the compiler. The block diagram 300 can include a hazard identification component 342. Recall that a hazard can exist when valid data is not available for a memory access load operation requesting the data. Further, a hazard can exist when valid data would be overwritten by a memory access store operation. In embodiments, the hazards can include write-after-read, read-after-write, and write-after-write conflicts. The access buffers can be used as part of a hazard identification technique. Updated memory access store data may be available in the access buffer prior to the data being stored to memory. A determination of whether requested data is still within the access buffer rather than already in the memory can be made by comparing load and store addresses 344. Further embodiments include identifying hazardous loads and stores by comparing load and store addresses to contents of an access buffer. Recall that hazards can occur when conflicting or mistimed memory access operations are executed. In embodiments, the comparing can identify potential accesses to the same address. The comparing can further include using the precedence information that was used to tag memory access operations.

The system block diagram includes a data promotion delay component 346. The delay component can be used to avoid the various types of memory access hazards. Further embodiments can include delaying promoting data to the access buffer and/or releasing data from the access buffer. The delaying the promoting and/or releasing of data enables the data to be made available to an operation executing on a compute element when the data is required. In embodiments, the avoiding hazards can be based on a comparative precedence value. The comparative precedence value can be used to determine an amount of delay required to avoid a hazard. The block diagram 300 includes a hazard mitigation component 348. The identifying the hazards enables the identified hazards to be mitigated. Recall that data produced by executing data operations on one or more compute elements within the array is loaded into the access buffers prior to the data being stored into memory. As a result, data needed by a subsequent operation may still be located within the access buffers rather than at a target address specified by the operation. Discussed previously, load and store addresses can be compared to contents of an access buffer. In embodiments, the access buffer can be based on a content addressable memory.

The system block diagram 300 can include a load/store forwarding component 350. The load/store forwarding component can access contents of one or more access buffers. The accessed data can be provided or received for load or store operations respectively to accomplish hazard mitigation. In embodiments, the hazard mitigation can include load-to-store forwarding, store-to-load forwarding, and store-to-store forwarding. The forwarding is based on accessing data within one or more access buffers rather than from the memory. The system block diagram 300 can include a store probes component 352. The store probes component can examine pending data cache accesses for hazards. The examining the pending data cache accesses can include a store probe, where the store probe examines the data cache accesses for the addresses to be accessed. In embodiments, the examining can include interrogating the access buffer for pending load or store addresses. The pending load or store addresses can be analyzed based on two or more access operations to the same address, a potential order of the accesses to an address, etc. In embodiments, the interrogating can compare a store probe address to the pending load or store addresses. The interrogating can be used for detecting hazards. In embodiments the hazards can include write-after-read, read-after-write, and write-after-write conflicts, and so on. Store data can be committed to the data cache based on the store probe.

The system block diagram includes a memory data cache 360. The cache can include one or more levels of cache. In embodiments, the cache can include levels such as a level 1 (L1) cache, a level 2 (L2) cache, a level 3 (L3) cache, and so on. The L1 cache can include a small, fast memory that is accessible to the compute elements within the compute element array. The L2 cache can be larger than the L1 cache, and the L3 cache can be larger than the L2 cache and the L1 cache. When a compute element within the array initiates a load operation, the data associated with the load operation is first sought in the L1 cache, then the L2 cache if absent from the L1 cache, then the L3 cache if the load operation causes a “miss” (e.g., the requested data is not located in a cache level). The L1 cache, the L2 cache, and the L3 cache can store data, control words, compressed control words, and so on. In embodiments, the L3 cache can comprise a unified cache for data and compressed control words (CCWs).

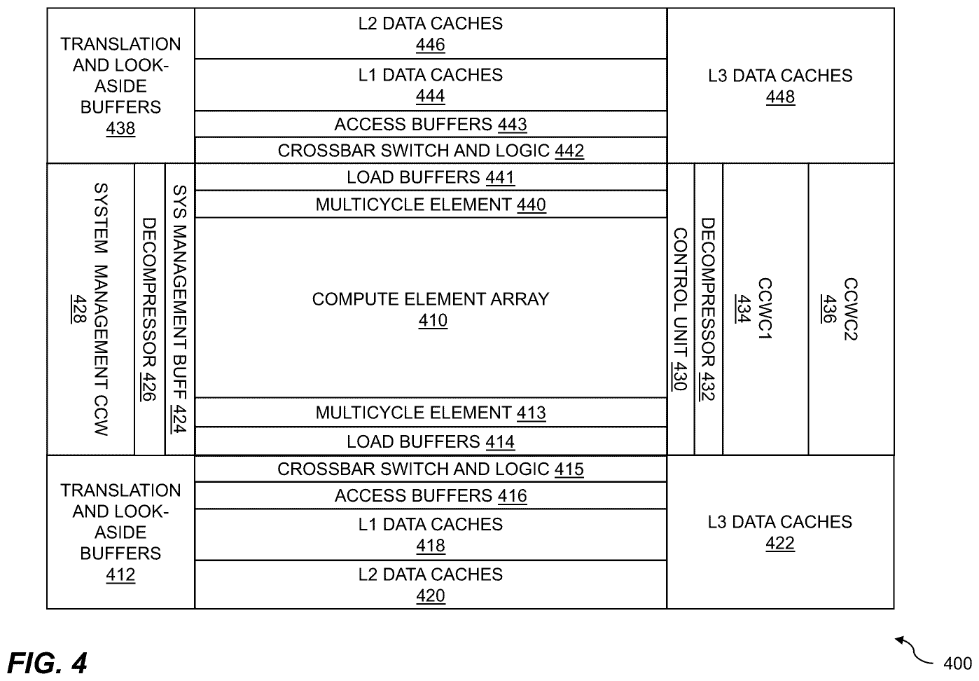

FIG. 4 is a system block diagram for a highly parallel architecture with a shallow pipeline. The highly parallel architecture can comprise a variety of components such as compute elements, processing elements, buffers, one or more levels of cache storage, system management, arithmetic logic units, multipliers, memory management units, and so on. The various components can be used to accomplish parallel processing of tasks, subtasks, and the like. The parallel processing is associated with program execution, job processing, etc. The parallel processing is enabled based on parallel processing with hazard detection and store probes. An array of compute elements is accessed, wherein each compute element within the array of compute elements is known to a compiler and is coupled to its neighboring compute elements within the array of compute elements. Control for the compute elements is provided on a cycle-by-cycle basis, wherein control is enabled by a stream of wide control words generated by the compiler. Data to be stored by the array of compute elements is managed, wherein the data to be stored is targeted to a data cache coupled to the array of compute elements, and wherein the managing includes detecting and mitigating memory hazards. Pending data cache accesses are examined for hazards, wherein the examining comprises a store probe. Store data is committed to the data cache, wherein the committing is based on a result of the store probe.

A system block diagram 400 for a highly parallel architecture with a shallow pipeline is shown. The system block diagram can include a compute element array 410. The compute element array 410 can be based on compute elements, where the compute elements can include processors, central processing units (CPUs), graphics processing units (GPUs), coprocessors, and so on. The compute elements can be based on processing cores configured within chips such as application specific integrated circuits (ASICs), processing cores programmed into programmable chips such as field programmable gate arrays (FPGAs), and so on. The compute elements can comprise a homogeneous array of compute elements. The system block diagram 400 can include translation and look-aside buffers such as translation and look-aside buffers 412 and 438. The translation and look-aside buffers can comprise memory caches, where the memory caches can be used to reduce storage access times.

The system block diagram 400 can include logic for load and store access order and selection. The logic for load and store access order and selection can include crossbar switch and logic 415 along with crossbar switch and logic 442. Crossbar switch and logic 415 can accomplish load and store access order and selection for the lower data cache blocks (418 and 420), and crossbar switch and logic 442 can accomplish load and store access order and selection for the upper data cache blocks (444 and 446). Crossbar switch and logic 415 enables high-speed data communication between the lower-half compute elements of compute element array 410 and data caches 418 and 420 using access buffers 416. Crossbar switch and logic 442 enables high-speed data communication between the upper-half compute elements of compute element array 410 and data caches 444 and 446 using access buffers 443. The access buffers 416 and 443 allow logic 415 and logic 442, respectively, to hold, load, or store data until any memory hazards are resolved. In addition, splitting the data cache between physically adjacent regions of the compute element array can enable the doubling of load access bandwidth, the reducing of interconnect complexity, and so on. While loads can be split, stores can be driven to both lower data caches 418 and 420 and upper data caches 444 and 446.

The system block diagram 400 can include lower load buffers 414 and upper load buffers 441. The load buffers can provide temporary storage for memory load data so that it is ready for low latency access by the compute element array 410. The system block diagram can include dual level 1 (L1) data caches, such as L1 data caches 418 and 444. The L1 data caches can be used to hold blocks of load and/or store data, such as data to be processed together, data to be processed sequentially, and so on. The L1 cache can include a small, fast memory that is quickly accessible by the compute elements and other components. The system block diagram can include level 2 (L2) data caches. The L2 caches can include L2 caches 420 and 446. The L2 caches can include larger, slower storage in comparison to the L1 caches. The L2 caches can store “next up” data, results such as intermediate results, and so on. The L1 and L2 caches can further be coupled to level 3 (L3) caches. The L3 caches can include L3 caches 422 and 448. The L3 caches can be larger than the L2 and L1 caches and can include slower storage. Accessing data from L3 caches is still faster than accessing main storage. In embodiments, the L1, L2, and L3 caches can include 4-way set associative caches.

The system block diagram 400 can include lower multicycle element 413 and upper multicycle element 440. The multicycle elements (MEMs) can provide efficient functionality for operations, such as multiplication operations, that span multiple cycles. The MEMs can provide further functionality for operations that can be of indeterminant cycle length, such as some division operations, square root operations, and the like. The MEMs can operate on data coming out of the compute element array and/or data moving into the compute element array. Multicycle element 413 can be coupled to the compute element array 410 and load buffers 414, and multicycle element 440 can be coupled to compute element array 410 and load buffers 441.

The system block diagram 400 can include a system management buffer 424. The system management buffer can be used to store system management codes or control words that can be used to control the array 410 of compute elements. The system management buffer can be employed for holding opcodes, codes, routines, functions, etc. which can be used for exception or error handling, management of the parallel architecture for processing tasks, and so on. The system management buffer can be coupled to a decompressor 426. The decompressor can be used to decompress system management compressed control words (CCWs) from system management compressed control word buffer 428 and can store the decompressed system management control words in the system management buffer 424. The compressed system management control words can require less storage than the decompressed control words. The system management CCW component 428 can also include a spill buffer. The spill buffer can comprise a large static random-access memory (SRAM), which can be used to provide rapid support of multiple nested levels of exceptions.

The compute elements within the array of compute elements can be controlled by a control unit such as control unit 430. While the compiler, through the control word, controls the individual elements, the control unit can pause the array to ensure that new control words are not driven into the array. The control unit can receive a decompressed control word from a decompressor 432 and can drive out the decompressed control word into the appropriate compute elements of compute element array 410. The decompressor can decompress a control word (discussed below) to enable or idle rows or columns of compute elements, to enable or idle individual compute elements, to transmit control words to individual compute elements, etc. The decompressor can be coupled to a compressed control word store such as compressed control word cache 1 (CCWC1) 434. CCWC1 can include a cache such as an L1 cache that includes one or more compressed control words. CCWC1 can be coupled to a further compressed control word store such as compressed control word cache 2 (CCWC2) 436. CCWC2 can be used as an L2 cache for compressed control words. CCWC2 can be larger and slower than CCWC1. In embodiments, CCWC1 and CCWC2 can include 4-way set associativity. In embodiments, the CCWC1 cache can contain decompressed control words, in which case it could be designated as DCWC1. In that case, decompressor 432 can be coupled between CCWC1 434 (now DCWC1) and CCWC2 436.

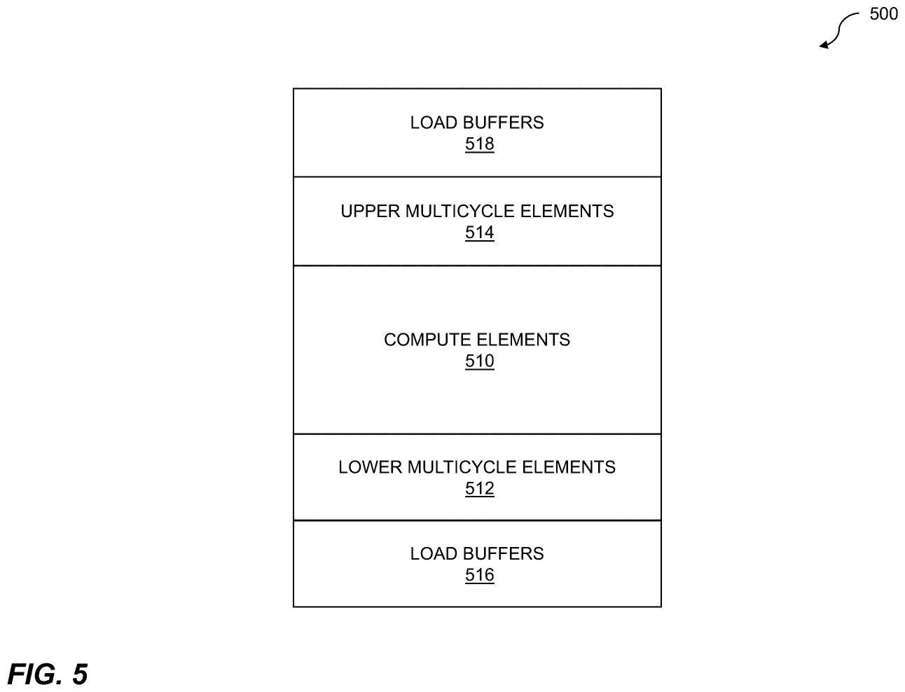

FIG. 5 shows compute element array detail 500. A compute element array can be coupled to components which enable the compute elements within the array of compute elements to process one or more tasks, subtasks, and so on. The components can access and provide data, perform specific high-speed operations, and the like. The components can be configured into a variety of computational topologies. The compute element array and its associated components enable parallel processing with hazard detection and store probes. The compute element array 510 can perform a variety of processing tasks, where the processing tasks can include operations such as arithmetic, vector, matrix, or tensor operations; audio and video processing operations; neural network operations; etc. The compute elements can be coupled to multicycle elements such as lower multicycle elements 512 and upper multicycle elements 514. The multicycle elements can provide functionality to perform, for example, high-speed multiplications associated with general processing tasks, multiplications associated with neural networks such as deep learning networks, multiplications associated with vector operations, and so on. The multiplication operations can span multiple cycles. The MEMs can provide further functionality for operations that can be of indeterminant cycle length, such as some division operations, square root operations, and the like.

The compute elements can be coupled to load buffers such as load buffers 516 and load buffers 518. The load buffers can be coupled to the L1 data caches as discussed previously. In embodiments, a crossbar switch (not shown) can be coupled between the load buffers and the data caches. The load buffers can be used to load storage access requests from the compute elements. When an element is not explicitly controlled, it can be placed in the idle (or low power) state. No operation is performed, but ring buses can continue to operate in a “pass thru” mode to allow the rest of the array to operate properly. When a compute element is used just to route data unchanged through its ALU, it is still considered active.

While the array of compute elements is paused, background loading of the array from the memories (data memory and control word memory) can be performed. The memory systems can be free running and can continue to operate while the array is paused. Because multicycle latency can occur due to control signal transport that results in additional “dead time”, allowing the memory system to “reach into” the array and to deliver load data to appropriate scratchpad memories while the array is paused can be beneficial. This mechanism can operate such that the array state is known, as far as the compiler is concerned. When array operation resumes after a pause, new load data will have arrived at a scratchpad, as required for the compiler to maintain the statically scheduled model.

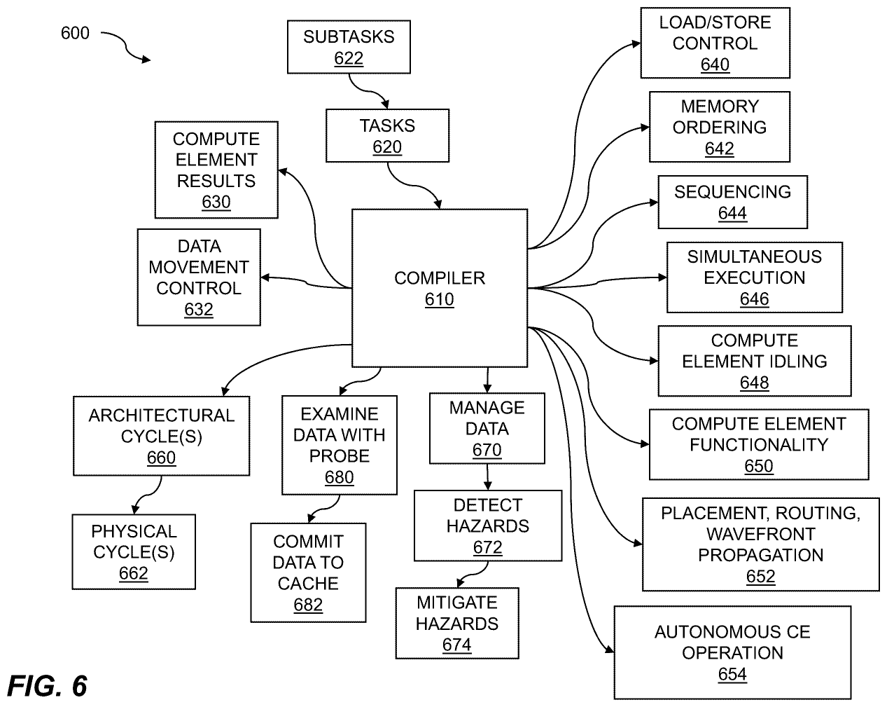

FIG. 6 is a system block diagram for compiler interactions. Discussed throughout, compute elements within an array are known to a compiler which can compile codes, processes, tasks, subtasks, and so on for execution on the array. The compiled tasks, subtasks, etc. comprise operations which can be executed on one or more compute elements within the array. The compiled tasks and subtasks are executed to accomplish task processing. The task processing can be accomplished based on parallel processing of the tasks and subtasks. Processing the tasks and subtasks includes accessing memory such a data memory, a cache, a scratchpad memory, etc. The memory accesses can cause memory access hazards if the memory accesses are not carefully orchestrated. A variety of interactions, such as placement of tasks on processors, routing of data among processors, and so on, can be associated with the compiler. The compiler interactions enable parallel processing with hazard detection and store probes. An array of compute elements is accessed, wherein each compute element within the array of compute elements is known to a compiler and is coupled to its neighboring compute elements within the array of compute elements. Control for the compute elements is provided on a cycle-by-cycle basis, wherein control is enabled by a stream of wide control words generated by the compiler. Data to be stored by the array of compute elements is managed, wherein the data to be stored is targeted to a data cache coupled to the array of compute elements, and wherein the managing includes detecting and mitigating memory hazards. Pending data cache accesses are examined for hazards, wherein the examining comprises a store probe. Store data is committed to the data cache, wherein the committing is based on a result of the store probe.

The system block diagram 600 includes a compiler 610. The compiler can include a high-level compiler such as a C, C++, Python, or similar compiler. The compiler can include a compiler implemented for a hardware description language such as a VHDL™ or Verilog™ compiler. The compiler can include a compiler for a portable, language-independent, intermediate representation such as low-level virtual machine (LLVM) intermediate representation (IR). The compiler can generate a set of directions that can be provided to the compute elements and other elements within the array. The compiler can be used to compile tasks 620. The tasks can include a plurality of tasks associated with a processing task. The tasks can further include a plurality of subtasks 622. The tasks can be based on an application such as a video processing or audio processing application. In embodiments, the tasks can be associated with machine learning functionality. The compiler can generate directions for handling compute element results 630. The compute element results can include results derived from arithmetic, vector, array, and matrix operations; Boolean operations; and so on. In embodiments, the compute element results are generated in parallel in the array of compute elements. Parallel results can be generated by compute elements, where the compute elements can share input data, use independent data, and the like. The compiler can generate a set of directions that controls data movement 632 for the array of compute elements. The control of data movement can include movement of data to, from, and among compute elements within the array of compute elements. The control of data movement can include loading and storing data, such as temporary data storage, during data movement. In other embodiments, the data movement can include intra-array data movement.

As with a general-purpose compiler used for generating tasks and subtasks for execution on one or more processors, the compiler 610 can provide directions for task and subtask handling, input data handling, intermediate and resultant data handling, and so on. The directions can include one or more operations, where the one or more operations can be executed by one or more compute elements within the array of compute elements. The compiler can further generate directions for configuring the compute elements, storage elements, control units, ALUs, and so on, associated with the array. As previously discussed, the compiler generates directions for data handling to support the task handling. In the system block diagram, the data movement can include loads and stores 640 with a memory array. The loads and stores can include handling various data types such as integer, real or float, double-precision, character, and other data types. The loads and stores can load and store data into local storage such as registers, register files, caches, and the like. The caches can include one or more levels of cache such as a level 1 (L1) cache, a level 2 (L2) cache, a level 3 (L3) cache, and so on. The loads and stores can also be associated with storage such as shared memory, distributed memory, etc. In addition to the loads and stores, the compiler can handle other memory and storage management operations including memory precedence. In the system block diagram, the memory access precedence can enable ordering of memory data 642. Memory data can be ordered based on task data requirements, subtask data requirements, and so on. The memory data ordering can enable parallel execution of tasks and subtasks.

In the system block diagram 600, the ordering of memory data can enable compute element result sequencing 644. In order for task processing to be accomplished successfully, tasks and subtasks must be executed in an order that can accommodate task priority, task precedence, a schedule of operations, and so on. The memory data can be ordered such that the data required by the tasks and subtasks can be available for processing when the tasks and subtasks are scheduled to be executed. The results of the processing of the data by the tasks and subtasks can therefore be ordered to optimize task execution, to reduce or eliminate memory contention conflicts, etc. The system block diagram includes enabling simultaneous execution 646 of two or more potential compiled task outcomes based on the set of directions. The code that is compiled by the compiler can include branch points, where the branch points can include computations or flow control. Flow control transfers program execution to a different sequence of control words. Since the result of a branch decision, for example, is not known a priori, the initial operations associated with both paths are encoded in the currently executing control word stream. When the correct result of the branch is determined, then the sequence of control words associated with the correct branch result continues execution, while the operations for the branch path not taken are halted and side effects may be flushed. In embodiments, the two or more potential branch paths can be executed on spatially separate compute elements within the array of compute elements.

The system block diagram includes compute element idling 648. In embodiments, the set of directions from the compiler can idle an unneeded compute element within a row of compute elements located in the array of compute elements. Not all of the compute elements may be needed for processing, depending on the tasks, subtasks, and so on that are being processed. The compute elements may not be needed simply because there are fewer tasks to execute than there are compute elements available within the array. In embodiments, the idling can be controlled by a single bit in the control word generated by the compiler. In the system block diagram, compute elements within the array can be configured for various compute element functionalities 650. The compute element functionality can enable various types of compute architectures, processing configurations, and the like. In embodiments, the set of directions can enable machine learning functionality. The machine learning functionality can be trained to process various types of data such as image data, audio data, medical data, etc. In embodiments, the machine learning functionality can include neural network implementation. The neural network can include a convolutional neural network, a recurrent neural network, a deep learning network, and the like. The system block diagram can include compute element placement, results routing, and computation wave-front propagation 652 within the array of compute elements. The compiler can generate directions that can place tasks and subtasks on compute elements within the array. The placement can include placing tasks and subtasks based on data dependencies between or among the tasks or subtasks, placing tasks that avoid memory conflicts or communications conflicts, etc. The directions can also enable computation wave-front propagation. Computation wave-front propagation can implement and control how execution of tasks and subtasks proceeds through the array of compute elements. The system block diagram 600 can include autonomous compute element (CE) operation 654. As described throughout, autonomous CE operation enables one or more operations to occur outside of direct control word management.

In the system block diagram, the compiler can control architectural cycles 660. An architectural cycle can include an abstract cycle that is associated with the elements within the array of elements. The elements of the array can include compute elements, storage elements, control elements, ALUs, and so on. An architectural cycle can include an “abstract” cycle, where an abstract cycle can refer to a variety of architecture level operations such as a load cycle, an execute cycle, a write cycle, and so on. The architectural cycles can refer to macro-operations of the architecture rather than to low level operations. One or more architectural cycles are controlled by the compiler. Execution of an architectural cycle can be dependent on two or more conditions. In embodiments, an architectural cycle can occur when a control word is available to be pipelined into the array of compute elements and when all data dependencies are met. That is, the array of compute elements does not have to wait for either dependent data to load or for a full memory buffer to clear. In the system block diagram, the architectural cycle can include one or more physical cycles 662. A physical cycle can refer to one or more cycles at the element level required to implement a load, an execute, a write, and so on. In embodiments, the set of directions can control the array of compute elements on a physical cycle-by-cycle basis. The physical cycles can be based on a clock such as a local, module, or system clock, or some other timing or synchronizing technique. In embodiments, the physical cycle-by-cycle basis can include an architectural cycle. The physical cycles can be based on an enable signal for each element of the array of elements, while the architectural cycle can be based on a global, architectural signal. In embodiments, the compiler can provide, via the control word, valid bits for each column of the array of compute elements, on the cycle-by-cycle basis. A valid bit can indicate that data is valid and ready for processing, that an address such as a jump address is valid, and the like. In embodiments, the valid bits can indicate that a valid memory load access is emerging from the array. The valid memory load access from the array can be used to access data within a memory or storage element. In other embodiments, the compiler can provide, via the control word, operand size information for each column of the array of compute elements. Various operand sizes can be used. In embodiments, the operand size can include bytes, half-words, words, and doublewords.

The system block diagram 600 includes data management 670. The data management can include managing data to be stored by the array of compute elements. The data can be stored in a local cache, a shared cache, a system memory, and so on. In embodiments, the data to be stored can be targeted to a data cache coupled to the array of compute elements. The data cache can be coupled between the array of compute elements and a shared memory such as a multilevel cache memory, a main memory, and the like. The data management can be accomplished using various techniques including tagging, labeling, prioritizing, etc. In embodiments, the compiler can be used to tag the data to be stored with precedence information. The precedence information can include a data priority, data access order, etc. The precedence tag can include a tag within a moving window. The moving window can include an amount of time, one or more cycles such as architectural cycles, and the like. In embodiments, the tagging can be contained in the control words, where the control words can include control words provided on a cycle-by-cycle basis. The control words are generated by the compiler. In further embodiments, the tagging is provided by the compiler at compile time. Discussed previously, memory access load data and store data can transit a crossbar switch. In further embodiments, the data to be stored can be transferred between the array of compute elements and access buffers associated with the data cache using a crossbar switch. The transferring of memory access data crossbar switch experiences a delay, where the delay can be based on the crossbar switch configuration, other memory access operations that occur within a cycle, etc. The delay is unknown to the compiler at compile time. In embodiments, the unique precedence tag can enable data store access priority in the crossbar switch.

The system block diagram 600 includes hazard detection 672. A hazard can occur when more than one data store request accesses the same storage address within a local cache, when the contents of the local cache are different from the contents of the main memory, and so on. The hazard can occur because storing data can change the contents at the storage location. The data to be stored, if committed too early or too late, can cause invalid data to be used by one or more processors. In a usage example, a processor P1 has processed data to be stored at location 1. Processor P2 needs to read the contents of location 1 prior to the data at location 1 being changed by the data processed by P1. A hazard occurs if the data at location 1 is changed by storing data from processor P1 prior to the old data being read by processor P2. The system block diagram 600 includes hazard mitigation 674. Discussed previously, various techniques, such as tagging the data to be stored, can be used to mitigate hazards. The tagging can be provided by the compiler at compile time. The tagging can include access order, access priority, access precedence, and so on. In other embodiments, the hazards can be mitigated using a holding technique. Pending data cache access can be held prior to committing the store data to the data cache. The holding is described in greater detail below.

Discussed previously and throughout, data such as processed data to be stored by the array of compute elements can be examined. The examining of the data can enable hazard detection and hazard mitigation. The system block diagram 600 includes data examination 680. The examining data is accomplished using store probes. A store probe can be used to examine or “probe” store data requests. The store data requests can be generated by one or more compute elements. The probing can include examining one or more buffers such as access buffers for potential hazards. In embodiments, the access buffers can be coupled to the array of compute elements through a crossbar switch. The access buffers can be accessible to the array of compute elements and can hold one or more sets of data to be stored to the data cache. Since one or more compute elements can use different access buffers for data to be stored or targeted to the data cache, the probes can access one or more of the access buffers. In embodiments, the examining can include interrogating the access buffer for pending load or store addresses. The interrogating can provide an address for comparison with addresses associated with pending load and store operations. In embodiments, the interrogating can compare a store probe address to the pending load or store addresses. The comparing can be accomplished using various techniques, load buffer architectures, and so on. In embodiments, the load buffer can comprise a content addressable buffer.

The system block diagram 600 includes committing data 682. The data is committed to the data cache. The data cache can include a single level cache, a multilevel cache, and so on. In embodiments, the access buffers can hold data awaiting commitment to the data cache. The data stored within the access buffers can result from processing performed by the one or more compute elements. The data from the one or more compute elements can transit the crossbar switch to be stored in the one or more access buffers. Once committed, data within access buffers can be loaded into the data cache. The committing the data or delaying committing the data can be based on a result of the store probe. In embodiments, a result of the store probe indicating no hazard detection can enable data transfer from the access buffers to the array of compute elements. The no hazard detection can result from comparing load and store addresses to addresses of contents of the access buffer, and noting that the compared addresses to which the committed data is to be stored are not associated with pending operations such as data load operations. In other embodiments, a result of the store probe indicating no pending data awaiting commitment can enable data transfer from the array of compute elements to the access buffers. That is, transferring data from the array of compute elements will not overwrite data pending commitment to the data cache.

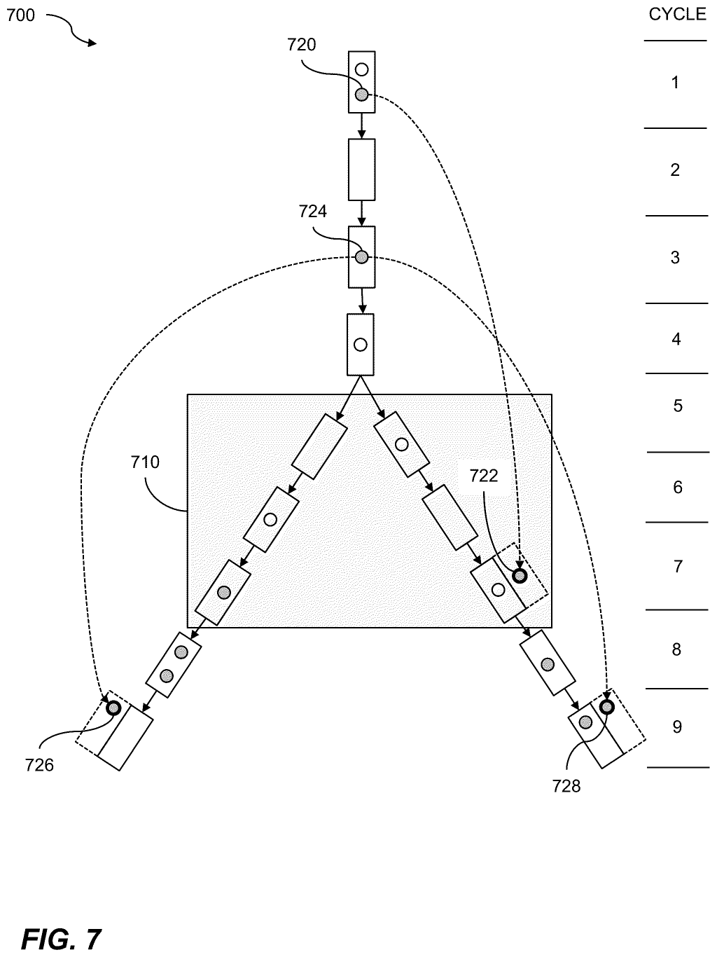

FIG. 7 shows branch handling for hazard detection and store probes. Branches can occur within processes, tasks, and subtasks that can be executed on compute elements within an array. The branch operations are based on decisions that are determined within code that implements the processes, tasks, subtasks, etc. The branch can be based on one or more logical operations such as AND, NAND, OR, NOR, XOR, XNOR operations, shift and rotate operations, and so on. The branches can be based on one or more arithmetic operations such as addition, subtraction, multiplication, division, etc. The branches can cause a context switch. To speed execution of branches when a branch decision is determined, operations and data associated with multiple branch paths that pertain to the branch decision can be fetched prior to the branch decision being made. Further, execution of the operations associated with each branch path can begin prior to the branch decision being made. When the branch decision is made, execution can continue for operations associated with the taken path, while the operations associated with one or more untaken paths can be halted.

The handling of branch paths and branch decisions can be complex because accessing data prior to the branch decision being determined can be rife with memory access hazards. The memory access hazards, which can include load (read) hazards and store (write) hazards, can include write-after-read conflicts, read-after-write conflicts, write-after-write conflicts, etc. The branch handling can be accomplished based on parallel processing with hazard detection and store probes. An array of compute elements is accessed, wherein cach compute element within the array of compute elements is known to a compiler and is coupled to its neighboring compute elements within the array of compute elements. Control for the compute elements is provided on a cycle-by-cycle basis, wherein control is enabled by a stream of wide control words generated by the compiler. Data to be stored by the array of compute elements is managed, wherein the data to be stored is targeted to a data cache coupled to the array of compute elements, and wherein the managing includes detecting and mitigating memory hazards. Pending data cache accesses are examined for hazards, wherein the examining comprises a store probe. Store data is committed to the data cache, wherein the committing is based on a result of the store probe.

The figure shows branch handling including hazard detection and mitigation 700. Recall that a hazard can occur when valid data is not available for loading when a compute element requests the data, when valid data is overwritten by store data before the valid data can be loaded or stored, and so on. Such hazards can be identified by comparing load and store addresses of memory access operations requested by compute element operations. In embodiments, the pending data cache accesses can be examined in the access buffer. Recall that memory access data can be held prior to promotion (e.g., storing into memory, loading into compute elements, holding in a buffer, etc.). As a result, data associated with memory access operations may still be located within buffers such as access buffers. Embodiments can include identifying hazardous loads and stores by comparing load and store addresses to contents of an access buffer. The comparing can be accomplished by comparing contents of the access buffer, and comparing addresses within the access buffer, among other techniques. In embodiments, the comparing can examine addresses and identify potential accesses to the same address. Additional information such as precedence information can be used to tag memory access operations. Further embodiments comprise including the precedence information in the comparing. The precedence information can provide further insight into identifying hazards by indicating an order of memory access operations, timing information such as a cycle or relative cycle in which a memory access operation takes place, etc.

Various techniques can be used for examining the contents of the access buffers for load and store hazards. The examining can include a store probe. In embodiments, the examining can include interrogating the access buffer for pending load or store addresses. Logic can be associated with the access buffer which can include logic to determine address matches between pending memory access loads and stores and addresses associated with memory access loads and stores within the access buffer. In embodiments, the interrogating compares a store probe address to the pending load or store addresses. The store probe address can be provided by a memory access requested generated by a compute element. Further embodiments can include identifying hazardous loads and stores by comparing load and store addresses to addresses of contents of the access buffer. The store probe address can be compared to pending load or store addresses already within the access buffer. In embodiments, the comparing can identify potential accesses to the same address. Potential accesses to the same address can cause one or more memory access hazards, depending on the order in which the accesses are performed. Discussed previously, further embodiments can include precedence information in the comparison. The precedence information can be based on execution precedence, execution order, priority, and so on. The precedence information can be used to allow or disallow committing data to the data cache. Further embodiments include delaying the promoting of data to the access buffer and/or the releasing of data from the access buffer. The delaying can be based on a number of cycles such as architectural cycles, completion of another operation, and the like. In embodiments, the delaying can avoid hazards. Further techniques can be used to avoid hazards. In other embodiments, the avoiding hazards can be based on a comparative precedence value.

In the figure, execution of compute element operations associated with control words provided on a cycle-by-cycle basis is shown. The operations include a branch operation which can be used to decide between two branch paths, a left side path and a right-side path. Discussed previously, the identifying memory access load and store hazards can enable hazard mitigation. In the example 700, speculative encoding within code words of both branch paths can enable “prefetching” of compute element operations and data manipulated by the operation. The prefetching can include loading data manipulated by operations associated with both paths. A branch shadow 710 can include a number of cycles during which operations associated with each branch path can be executed prior to the branch decision. In the example, the branch shadow can occur during cycles 5, 6, and 7. The branch shadow can correspond to execution of operations associated with cycles 2, 3, and 4. During the branch shadow, loading data from buffers such as access buffers cannot be allowed because the data in the access buffers may be updated during the cycles prior to the branch operation. As a result, the hazard mitigation techniques described before, namely hazard mitigation accomplished by load-to-store forwarding, store-to-load forwarding, and store-to-store forwarding, cannot be allowed. To ameliorate this problem, stores from the untaken branch path can be suppressed from departing the array. By suppressing the stores from the untaken branch path from departing the array, crossbar resources and access buffer resources can be preserved.

Returning to the figure, a compiled code snippet comprising nine control words includes a branch decision at control word 4. Each cycle can include a data load operation, a data processing operation, data store operations, and so on. In the figure, an open circle represents a store address and store data emerging from the array of compute elements; a filled circle represents a load address emerging from the array; and the bold, filled circle represents a scheduled load data pickup by the array. In the example, load and store access operations that emanate from the compute element array are not suppressed in the access buffers for branch paths not taken during the branch shadow 710. The “not suppressing” load operations and store operations can maximize throughput and minimize latency of a crossbar switch coupled between the compute element array and the access buffers. A precedence tag associated with cycle 1 720 can indicate cycle 7 722, the cycle during which the load data is taken up by the array for processing. Similarly, a precedence tag associated with cycle 3 724 can indicate right-hand branch path cycle 9 726 and its branch analog, left-hand branch path cycle 9 728. Cycle 9 is the cycle during which the load data, indicated with cycle 3, is taken up by the array for processing. If the branch decision in cycle 4 indicates to proceed down the right-hand side branch (e.g., the taken path), then the load in cycle 6 and the store in cycle 7 of the left-hand side branch (e.g., the not taken path) can be suppressed or ignored prior to entry to the crossbar switch. The two store operations in cycle 8 of the left-hand side branch are not executed because the code illustrated in the code snippet has branched away from this the left-hand branch within the array.

The store memory access store operations associated with cycles 1, 4, and 5 can be aliased into the load operation issued in cycle 1 720 to ameliorate a read-after-write hazard associated with the right-hand path. The store operations associated with cycles 4, 5, and 7 can be aliased into the load operation issued in cycle 3 724 to ameliorate a read-after-write hazard associated with the right-hand path. The store operations associated with cycles 4 and 6 can alias into the load operation issued in cycle 3 to ameliorate a read-after-write hazard associated with the left-hand path. The store operation associated with cycle 8 can be aliased to the other store operation associated with cycle 8 to ameliorate a write-after-write hazard for the left-hand path.

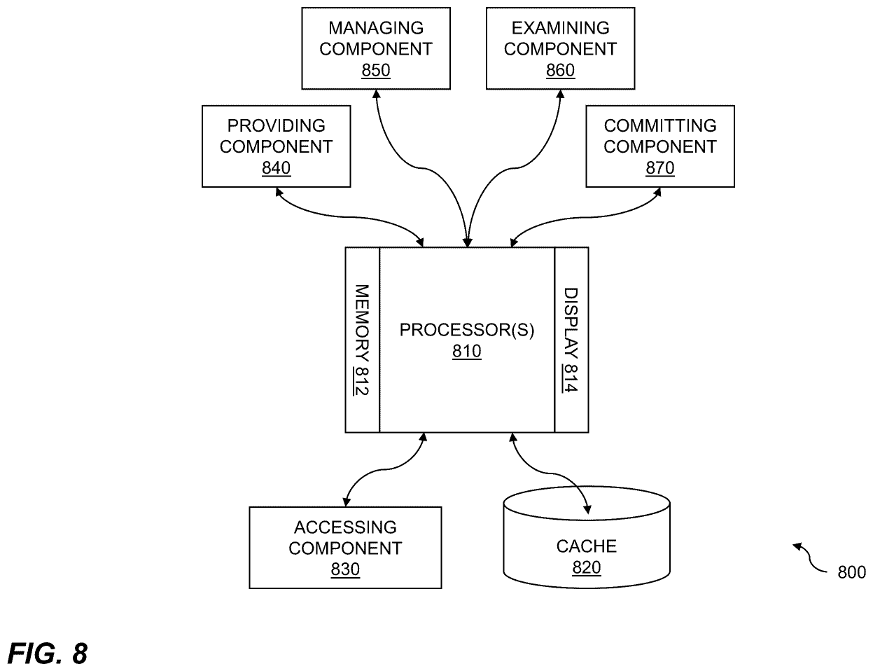

FIG. 8 is a system diagram for parallel processing. The parallel processing is enabled by parallel processing with hazard detection and store probes. The system 800 can include one or more processors 810, which are coupled to a memory 812 which stores instructions. The system 800 can further include a display 814 coupled to the one or more processors 810 for displaying data and information; store probes; tagging information such as precedence information; intermediate steps; directions; compressed control words; fixed-length control words; control words implementing Very Long Instruction Word (VLIW) functionality; topologies including systolic, vector, cyclic, spatial, streaming, or VLIW topologies; and so on. In embodiments, one or more processors 810 are coupled to the memory 812, wherein the one or more processors, when executing the instructions which are stored, are configured to: access an array of compute elements, wherein each compute element within the array of compute elements is known to a compiler and is coupled to its neighboring compute elements within the array of compute elements; provide control for the compute elements on a cycle-by-cycle basis, wherein control is enabled by a stream of wide control words generated by the compiler; manage data to be stored by the array of compute elements, wherein the data to be stored is targeted to a data cache coupled to the array of compute elements, and wherein the managing includes detecting and mitigating memory hazards; examine pending data cache accesses for hazards, wherein the examining comprises a store probe; and commit store data to the data cache, wherein the committing is based on a result of the store probe. The plurality of compressed control words is decompressed by hardware associated with the array of compute elements and is driven into the array. The plurality of compressed control words is decompressed into fixed-length control words that comprise one or more compute element operations. The compute element operations are executed within the array of compute elements. The compute elements can include compute elements within one or more integrated circuits or chips; compute elements or cores configured within one or more programmable chips such as application specific integrated circuits (ASICs); field programmable gate arrays (FPGAs); heterogeneous processors configured as a mesh; standalone processors; etc.

The system 800 can include a cache 820. The cache 820 can be used to store data such as store probes and store probe responses, tagging information such as memory access hazard information; precedence information; directions to compute elements; decompressed, fixed-length control words; compute element operations associated with decompressed control words; intermediate results; microcode; branch decisions; and so on. The cache can comprise a small, local, easily accessible memory available to one or more compute elements. The data cache can be coupled to an access buffer. The access buffer can be used to hold store data prior to committing the store data to the data cache. The cache can further contain precedence information which enables hardware ordering of memory access loads to the array of compute elements and memory access stores from the array of compute elements. The precedence information can provide semantically correct operation ordering. The data that is stored within the cache can further include linking information; compressed control words; decompressed, fixed-length control words; etc. Embodiments include storing relevant portions of a control word within the cache associated with the array of compute elements. The cache can be accessible to one or more compute elements. The cache, if present, can include a dual read, single write (2R1 W) cache. That is, the 2R1 W cache can enable two read operations and one write operation contemporaneously without the read and write operations interfering with one another. The cache can be coupled to operate in cooperation with, etc. scratchpad storage. The scratchpad storage can include a small, fast, local memory element coupled to one or more compute elements. In embodiments, the scratchpad storage can act as a “level zero” or L0 cache within a multi-level cache storage hardware configuration.

The system 800 can include an accessing component 830. The accessing component 830 can include control logic and functions for accessing an array of compute elements. Each compute element within the array of compute elements is known to a compiler and is coupled to its neighboring compute elements within the array of compute elements. A compute element can include one or more processors, processor cores, processor macros, and so on. Each compute element can include an amount of local storage. The local storage may be accessible to one or more compute elements. Each compute element can communicate with neighbors, where the neighbors can include nearest neighbors or more remote “neighbors”. Communication between and among compute elements can be accomplished using a bus such as an industry standard bus, a ring bus, a network such as a wired or wireless computer network, etc. In embodiments, the ring bus is implemented as a distributed multiplexor (MUX).

The system 800 can include a providing component 840. The providing component 840 can include control and functions for providing control for the compute elements on a cycle-by-cycle basis, wherein control is enabled by a stream of wide control words generated by the compiler. The plurality of control words enables compute element configuration and operation execution, compute element memory access, inter-compute element communication, etc., on a cycle-by-cycle basis. The compute element configuration can include scheduling of the compute elements. In embodiments, the compiler provides static scheduling for the array of compute elements. The control words can further include variable bit-length control words, compressed control words, and so on. The control words can be based on low-level control words such as assembly language words, microcode words, firmware words, and so on. In embodiments, the stream of wide, variable length control words generated by the compiler provides direct fine-grained control of the 2D array of compute elements. The compute operations can include a read-modify-write operation. The compute operations can enable audio or video processing, artificial intelligence processing, machine learning, deep learning, and the like. The providing control can be based on microcode control words, where the microcode control words can include opcode fields, data fields, compute array configuration fields, etc. The compiler that generates the control can include a general-purpose compiler, a parallelizing compiler, a compiler optimized for the array of compute elements, a compiler specialized to perform one or more processing tasks, and so on. The providing control can implement one or more topologies such as processing topologies within the array of compute elements. In embodiments, the topologies implemented within the array of compute elements can include a systolic, a vector, a cyclic, a spatial, a streaming, or a Very Long Instruction Word (VLIW) topology. Other topologies can include a neural network topology. The control can enable machine learning functionality for the neural network topology.

The control of the array of compute elements on a cycle-by-cycle basis can include configuring the array to perform various compute operations. In embodiments, the stream of wide control words generated by the compiler provides direct fine-grained control of the 2D array of compute elements. The fine-grained control can include individually controlling each compute element, irrespective of type of compute element. A compute element type can include an integer, floating-point, address generation, write buffer, read buffer, and the like. The compute operations can include a read-modify-write operation. The compute operations can enable audio or video processing, artificial intelligence processing, machine learning, deep learning, and the like. The providing control can be based on microcode control words, where the microcode control words can include opcode fields, data fields, compute array configuration fields, etc. The compiler that generates the control can include a general-purpose compiler, a parallelizing compiler, a compiler optimized for the array of compute elements, a compiler specialized to perform one or more processing tasks, and so on. The providing control can implement one or more topologies, such as processing topologies, within the array of compute elements. In embodiments, the topologies implemented within the array of compute elements can include a systolic, a vector, a cyclic, a spatial, a streaming, or a Very Long Instruction Word (VLIW) topology. Other topologies can include a network topology such as a neural network topology, a Petri Net topology, etc. A control can enable machine learning functionality for the neural network topology.

In embodiments, the control word from the stream of wide control words can include a source address, a target address, a block size, and a stride. The target address can include an absolute address, a relative address, an indirect address, and so on. The block size can be based on a logical block size, a physical memory block size, and the like. In embodiments, the memory block transfer control logic can compute memory addresses. The memory addresses can be associated with memory coupled to the 2D array of compute elements, shared memory, a memory system, etc. Further embodiments can include using memory block transfer control logic. The memory block transfer control logic can include one or more dedicated logic blocks, configurable logic, etc. In embodiments, the memory block transfer control logic can be implemented outside of the 2D array of compute elements. The transfer control logic can include a logic element coupled to the 2D array. In other embodiments, the memory block transfer control logic can operate autonomously from the 2D array of compute elements. In a usage example, a control word that includes a memory block transfer request can be provided to the memory block transfer control logic. The logic can execute the memory block transfer while the 2D array of compute elements is processing control words, executing compute element operations, and the like. In other embodiments, the memory block transfer control logic can be augmented by configuring one or more compute elements from the 2D array of compute elements. The compute elements from the 2D array can provide interfacing operations between compute elements within the 2D array and the memory block transfer control logic. In other embodiments, the configuring can initialize compute element operation buffers within the one or more compute elements. The compute element operation buffers can be used to buffer control words, decompressed control words, portions of control words, etc. In further embodiments, the operation buffers can include bunch buffers. Recall that control words are based on bits. Sets of control word bits called bunches can be loaded into buffers called bunch buffers. The bunch buffers are coupled to compute elements and can control the compute elements. The control word bunches are used to configure the 2D array of compute elements, and to control the flow or transfer of data within and the processing of the tasks and subtasks on the compute elements within the array.

The control words that are generated by the compiler can further include a conditionality such as a branch. In embodiments, the control words can include branch operations. The branch can include a conditional branch, an unconditional branch, etc. The control words can be decompressed by a decompressor logic block that decompresses words from a compressed control word cache on their way to the array. In embodiments, the set of directions can include a spatial allocation of subtasks on one or more compute elements within the array of compute elements. In other embodiments, the set of directions can enable multiple, simultaneous programming loop instances circulating within the array of compute elements. The multiple programming loop instances can include multiple instances of the same programming loop, multiple programming loops, etc.

The system block diagram 800 can include a managing component 850. The managing component 850 can include control and functions for managing data to be stored by the array of compute elements, wherein the data to be stored is targeted to a data cache coupled to the array of compute elements, and wherein the managing includes detecting and mitigating memory hazards. The managing can be based on software techniques, hardware techniques, a combination of software and hardware techniques, and so on. In embodiments, the examining can occur in logic coupling the array of compute elements to the data cache. The managing can include receiving data from one or more compute elements within the array of compute elements. The managing can include loading data from the one or more compute elements into one or more access buffers. In embodiments, the access buffers are coupled between the array of compute elements and the data cache. The one or more access buffers can be further coupled to a crossbar switch. Recall that the data cache can include a single level cache, a multilevel cache, one or more shared levels of cache, and so on. The data that is managed can include data targeted to one or more addresses within the data cache. More than one compute element can process data targeted to an address, and storage access hazards can occur. The storage access hazards can be associated with the data cache. Further embodiments can include identifying hazardous loads and stores by comparing load and store addresses to addresses of contents of the access buffer. The identifying hazardous loads and stores enables proper execution of tasks, subtasks, and so on by identifying load-store timing conflicts. In embodiments, hazardous loads and stores can include write-after-read conflicts, read-after-write conflicts, and write-after-write conflicts. The managing data to be stored can include hazard mitigation. In embodiments, the identifying enables hazard mitigation. The hazard mitigation can be accomplished using a variety of techniques. In embodiments, the hazard mitigation can include load-to-store forwarding, store-to-load forwarding, and store-to-store forwarding. The forwarding techniques are based on accessing data within one or more access buffers rather than from the data cache or the memory.

The system 800 can include an examining component 860. The examining component 860 can include control and functions for examining pending data cache accesses for hazards, wherein the examining comprises a store probe. The store probe can examine one or more addresses associated with the pending data cache accesses. Various techniques can be used to accomplish the examining. In embodiments, the pending data cache accesses can be examined in the access buffer. The access buffer include can one or more pending accesses to the data cache. More than one pending data cache access can access one or more substantially similar addresses within the data cache. Thus, the order in which the pending data cache accesses are performed is critical to maintaining data integrity. Maintaining data integrity includes mitigating memory hazards. In embodiments, the examining can include interrogating the access buffer for pending load or store addresses. The interrogating can be based on providing one or more addresses to determine whether substantially similar addresses associated with data cache accesses are already present in the access buffer. In embodiments, the interrogating can be accomplished using logic associated with the access buffer. The interrogating can compare a store probe address to the pending load or store addresses. In embodiments, the examining occurs in logic coupling the array of compute elements to the data cache.

When an address associated with a store probe matches an address within the access buffers, additional techniques can be used to assist in determining an order of execution of the data cache accesses. Embodiments can include tagging data cache accesses with precedence information. The precedence information can be contained in the control words. The precedence information can be provided by the compiler at compile time. The data cache accesses can include load operations, store operations, data transfer operations, and so on. Each inbound access or load operation to the compute element array can be tagged with a precedence tag. In embodiments, the load operation is tagged with a unique precedence tag. The precedence tag can be a tag within a moving window such as a moving time window, a tag associated with a number of cycles such as architectural cycles, etc. In embodiments, the unique precedence tag can enable load access priority in the crossbar switch. The tagging can be used to disambiguate a given inbound access or load from other data cache accesses. An inbound data transfer load can include transferring data from an access buffer associated with a cache such as a data cache, through the crossbar switch, to a load buffer associated with the compute element array. Further embodiments include transferring memory access data between the array of compute elements and access buffers using a crossbar switch. In embodiments, a delay for the transferring can be unknown to the compiler. More than one memory access may be transiting a crossbar switch during a given cycle. Other data cache accesses can be transiting the crossbar switch more rapidly than the given memory access. Outbound data cache accesses or store operations can be tagged. Embodiments can include tagging store accesses with a unique precedence tag. The store access tags can also occur within a window such as a time window.

The system 800 can include a committing component 870. The committing component 870 can include control and functions for committing store data to the data cache, wherein the committing is based on a result of the store probe. The data to be committed to the data cache can include data generated by one or more compute elements within the array of compute elements. In embodiments, the access buffers can hold data awaiting commitment to the data cache. The access buffers can hold the data awaiting commitment as received from one or more compute elements, in an order based on the maintaining, and so on. The committing the data can be based on receiving a result of a store probe. In embodiments, a result of the store probe indicating no pending data awaiting commitment enables data transfer from the array of compute elements to the access buffers. When other data is awaiting commitment to the access buffers, then the other data may require committing to the access buffer prior to the data being committed to the access buffers. The order of the committing can be based on the store probes. The results of one or more store probes can be based on comparing addresses, ranking precedence tags, etc.

Recall that data cache access times, delays for transferring memory access data using the crossbar switch, and so on can be unknown to the compiler. Tagging data cache access operations with precedence information can enable local monitoring by a control element such as a control element associated with the compute element array. Such monitoring can be performed since in embodiments, the precedence information provides semantically correct operation ordering. Thus, compute element operation execution order, data dependencies, and so on, can be maintained. In embodiments, the precedence information can include intra-control word precedence and/or inter-control word precedence. The intra-control word precedence and/or inter-control word precedence can enable the semantically correct ordering of operations. The control words can include data-dependent operations, logical evaluation-dependent operations, and so on. In embodiments, the control words can include branch operations. In order to enhance parallel operation of the compute element array, compute element operations, data, etc. associated with two or more branch paths can be prefetched. Operations associated with the two or more branch paths can begin execution prior to the branch decision being made. When the branch decision is made, then further operations associated with the taken path can be executed while operations associated with the untaken path can be halted. Further embodiments can include suppressing the committing of data to the access buffers for untaken branch paths. The suppressing the committing of data for the untaken paths can include ignoring the access stores, overwriting the access stores, and so on. Further embodiments include augmenting the tagging at run time, based on the monitoring. The augmenting can be based on data cache access times, crossbar switch transit times, numbers of data transfers occurring within one or more cycles, and the like.

The tagging can be based on a status, where the status can include a value such as a number of cycles; a label such as valid, pending, or expired; and so on. The monitoring occurs as memory access operation is performed. The memory access operation can include accessing addresses associated with a memory system, transferring data to (e.g., load) or from (e.g., store) the 2D array, providing the data to or obtaining data from the target compute element, and so on. The executing the memory access operation can include one or more architectural cycles, physical cycles, and so on. The memory access operation can be monitored and controlled by a control unit. The control unit can further be used to control the array of compute elements on a cycle-by-cycle basis. The controlling can be enabled by the stream of wide control words generated by the compiler. The control words can be based on low-level control words such as assembly language words, microcode words, firmware words, and so on. The control words can be of variable length, such that a different number of operations for a differing plurality of compute elements can be conveyed in each control word. The control of the array of compute elements on a cycle-by-cycle basis can include configuring the array to perform various compute operations. In embodiments, the stream of wide control words comprises variable length control words generated by the compiler. In embodiments, the stream of wide, variable length control words generated by the compiler provides direct fine-grained control of the 2D array of compute elements. The compute operations can include a read-modify-write operation. The compute operations can enable audio or video processing, artificial intelligence processing, machine learning, deep learning, and the like. The providing control can be based on microcode control words, where the microcode control words can include opcode fields, data fields, compute array configuration fields, etc. The compiler that generates the control can include a general-purpose compiler, a parallelizing compiler, a compiler optimized for the array of compute elements, a compiler specialized to perform one or more processing tasks, and so on. The providing control can implement one or more topologies such as processing topologies within the array of compute elements. In embodiments, the topologies implemented within the array of compute elements can include a systolic, a vector, a cyclic, a spatial, a streaming, or a Very Long Instruction Word (VLIW) topology. Other topologies can include a neural network topology. A control can enable machine learning functionality for the neural network topology.

Mentioned previously, access buffer data can be held before promotion in order to avoid data cache access hazards such as load hazards and store hazards. The holding access buffer data can include delaying committing data. Further embodiments can include delaying the committing of data to the access buffer and/or the releasing of data from the access buffer. The delaying can be based on a number of cycles; an indication such as a flag, semaphore, or signal; etc. In embodiments, the delaying avoids hazards. Further embodiments can include identifying hazardous loads and stores by using store probes to compare load and store addresses to contents of an access buffer. A hazard can occur when loads and stores access substantially similar addresses in memory such as data memory cache. A hazardous load or store operation can include loading invalid data, overwriting valid data, and so on. In embodiments, the hazards can include write-after-read, read-after-write, and write-after-write conflicts, etc. Such hazards are particularly acute in parallel processing due to data dependencies between processes, tasks, subtasks; orders of execution of compute element operations; etc. In embodiments, the identifying enables hazard mitigation. The hazard mitigation can include hardware ordering of memory access loads and stores. Further embodiments comprise including the precedence information that results from the comparing. The precedence information can be used to order and coordinate compute element operations executed by compute elements within the array. In embodiments, the precedence information can provide semantically correct operation ordering. Various techniques can be used to accomplish hazard mitigation. In embodiments, the hazard mitigation can include load-to-store forwarding, store-to-load forwarding, store-to-store forwarding, and so on.

Further embodiments include decompressing the plurality of compressed control words. The decompressing the compressed control words can include enabling or disabling individual compute elements, rows or columns of compute elements, regions of compute elements, and so on. The decompressed control words can include one or more compute element operations. Further embodiments include executing operations within the array of compute elements using the plurality of compressed control words that were decompressed. The order in which the operations are executed is critical to successful processing such as parallel processing. In embodiments, the decompressor can operate on compressed control words that were ordered before they are presented to the array of compute elements. The operations that can be performed can include arithmetic operations, Boolean operations, matrix operations, neural network operations, and the like. The operations can be executed based on the control words generated by the compiler. The control words can be provided to a control unit, where the control unit can control the operations of the compute elements within the array of compute elements. Operation of the compute elements can include configuring the compute elements, providing data to the compute elements, routing and ordering results from the compute elements, and so on. In embodiments, the same decompressed control word can be executed on a given cycle across the array of compute elements. The control words can be decompressed to provide control on a per compute element basis, where each control word can be comprised of a plurality of compute element control groups or bunches. One or more control words can be stored in a compressed format within a memory such as a cache. The compression of the control words can greatly reduce storage requirements. In embodiments, the control unit can operate on decompressed control words. The executing operations contained in the control words can include distributed execution of operations. In embodiments, the distributed execution of operations can occur in two or more compute elements within the array of compute elements. Recall that the mapping of the virtual registers can include renaming by the compiler. In embodiments, the renaming can enable the compiler to orchestrate execution of operations using the physical register files.

The system 800 can include a computer program product embodied in a non-transitory computer readable medium for parallel processing, the computer program product comprising code which causes one or more processors to perform operations of: accessing an array of compute elements, wherein each compute element within the array of compute elements is known to a compiler and is coupled to its neighboring compute elements within the array of compute elements; providing control for the compute elements on a cycle-by-cycle basis, wherein control is enabled by a stream of wide control words generated by the compiler; managing data to be stored by the array of compute elements, wherein the data to be stored is targeted to a data cache coupled to the array of compute elements, and wherein the managing includes detecting and mitigating memory hazards; examining pending data cache accesses for hazards, wherein the examining comprises a store probe; and committing store data to the data cache, wherein the committing is based on a result of the store probe.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for parallel processing comprising:
accessing an array of compute elements, wherein each compute element within the array of compute elements is known to a compiler and is coupled to its neighboring compute elements within the array of compute elements;
providing control for the compute elements on a cycle-by-cycle basis, wherein control is enabled by a stream of wide control words generated by the compiler;
managing data to be stored by the array of compute elements, wherein the data to be stored is targeted to a data cache coupled to the array of compute elements, and wherein the managing includes detecting and mitigating memory hazards;
examining pending data cache accesses for hazards, wherein the examining comprises a store probe; and
committing store data to the data cache, wherein the committing is based on a result of the store probe.

2. The method of claim 1 further comprising coupling access buffers between the array of compute elements and the data cache.

3. The method of claim 2 wherein the access buffers are coupled to the array of compute elements through a crossbar switch.

4. The method of claim 2 wherein the pending data cache accesses are examined in the access buffer.

5. The method of claim 4 wherein the examining comprises interrogating the access buffer for pending load or store addresses.

6. The method of claim 5 wherein the interrogating compares a store probe address to the pending load or store addresses.

7. The method of claim 6 wherein the store probe address is not associated with a data field.

8. The method of claim 2 wherein the access buffers hold load data for the array of compute elements.

9. The method of claim 8 wherein the load data is being held for hazard detection and mitigation.

10. The method of claim 8 wherein a result of the store probe indicating no hazard detection enables data transfer from the access buffers to the array of compute elements.

11. The method of claim 2 wherein the access buffers hold data awaiting commitment to the data cache.

12. The method of claim 11 wherein a result of the store probe indicating no pending data awaiting commitment enables data transfer from the array of compute elements to the access buffers.

13. The method of claim 2 further comprising identifying hazardous loads and stores by comparing load and store addresses to addresses of contents of the access buffer.

14. The method of claim 13 wherein the comparing identifies potential accesses to the same address.

15. The method of claim 13 further comprising including precedence information in the comparing.

16. The method of claim 15 further comprising delaying promoting data to the access buffer and/or releasing data from the access buffer.

17. The method of claim 16 wherein the delaying avoids hazards.

18. The method of claim 17 wherein the avoiding hazards is based on a comparative precedence value.

19. The method of claim 13 wherein the hazardous loads and stores include write-after-read conflicts, read-after-write conflicts, and write-after-write conflicts.

20. The method of claim 13 wherein the identifying enables hazard mitigation.

21. The method of claim 20 wherein the hazard mitigation includes load-to-store forwarding, store-to-load forwarding, and store-to-store forwarding.

22. The method of claim 1 wherein the examining occurs in logic coupling the array of compute elements to the data cache.

23. The method of claim 1 wherein the compiler provides static scheduling for the array of compute elements.

24. The method of claim 1 wherein the wide control words are variable length control words.

25. A computer program product embodied in a non-transitory computer readable medium for parallel processing, the computer program product comprising code which causes one or more processors to perform operations of:
accessing an array of compute elements, wherein each compute element within the array of compute elements is known to a compiler and is coupled to its neighboring compute elements within the array of compute elements;
providing control for the compute elements on a cycle-by-cycle basis, wherein control is enabled by a stream of wide control words generated by the compiler;
managing data to be stored by the array of compute elements, wherein the data to be stored is targeted to a data cache coupled to the array of compute elements, and wherein the managing includes detecting and mitigating memory hazards;
examining pending data cache accesses for hazards, wherein the examining comprises a store probe; and
committing store data to the data cache, wherein the committing is based on a result of the store probe.

26. A computer system for parallel processing comprising:
a memory which stores instructions;
one or more processors coupled to the memory, wherein the one or more processors, when executing the instructions which are stored, are configured to:
access an array of compute elements, wherein each compute element within the array of compute elements is known to a compiler and is coupled to its neighboring compute elements within the array of compute elements;
provide control for the compute elements on a cycle-by-cycle basis, wherein control is enabled by a stream of wide control words generated by the compiler;
manage data to be stored by the array of compute elements, wherein the data to be stored is targeted to a data cache coupled to the array of compute elements, and wherein the managing includes detecting and mitigating memory hazards;
examine pending data cache accesses for hazards, wherein the examining comprises a store probe; and
commit store data to the data cache, wherein the committing is based on a result of the store probe.
